(19) United States
(12) Patent Application Publication
(10) Pub. No.: US 2012/0082240 A1
(43) Pub. Date: Apr. 5, 2012

(54) DECODING APPARATUS, DECODING METHOD, AND EDITING APPARATUS

(75) Inventors: Yousuke Takada, Hyogo (JP); Tomonori Matsuzaki, Hyogo (JP)

(73) Assignee: Thomson Licensing

(21) Appl. No.: 13/377,142

(22) PCT Filed: Jun. 9, 2009
(86) PCT No.: PCT/JP2009/002597

§ 371 Date: Dec. 8, 2011

(51) Int. Cl. H04N 7/26; G10L 19/00

(52) U.S. Cl. 375/240.24; 704/500; 375/E07.027

(57) ABSTRACT

There is disclosed an apparatus including: a source for providing encoded data of image data or audio data, the encoded data including a plurality of pieces of element data being able to be decoded independently, each of the plurality of pieces of element data including at least one block; first processing means for generating block information identifying a first block to be processed first among the at least one block; a plurality of second processing means for generating block information identifying a subsequent block to the first block based on an order of decoding processing in element data corresponding to the block information; a plurality of decoding means for decoding, in parallel, a block identified by referring to one piece of unreferenced block information among the generated block information; and storing means for storing the decoded block and forming decoded element data corresponding to the block. An editing apparatus including such an apparatus is also disclosed.

### TECHNICAL FIELD

The present invention relates to a decoding apparatus and a decoding method of encoded data, and in particular, relates to decoding processing of encoded data in which a plurality of processors operate in parallel.

### BACKGROUND ART

There exists a process and a thread as a unit of processing when a CPU executes a program. A plurality of processes can operate in parallel by using a multitasking function of an operating system. It is called a multi-process in which a plurality of processes operate in parallel to perform processing. However, since a memory is not basically shared among individual processes, the processing efficiency is low in the multi-process when performing processing which requires access to data on the same memory.

In contrast, one program can generate a plurality of threads and make the respective threads operate in parallel. It is called a multi-threading in which a plurality of threads operate in parallel to perform processing. When performing processing which requires access to data on the same memory, the processing efficiency is higher in the case of the multi-threading because a memory is shared among individual threads. By performing processing by assigning individual threads to a plurality of CPUs, the processing efficiency is further increased.

### Citation List

Patent Literature

PTL 1: Japanese Unexamined Patent Application, First Publication No. 2000-20323

PTL 2: Japanese Unexamined Patent Application, First Publication No. 2008-118616

### SUMMARY OF INVENTION

### Technical Problem

Hereinbelow, it is considered that N processing units that execute processing using

CPU resources are efficiently used to process one processing by dividing it into M units of processing which can be executed independently. Here, it is assumed that N and M are integers and N>=1 and M>=1. The M units of processing are assumed to be slices of MPEG2. The N processing units are assumed to correspond to N processors (CPU cores) in a one-to-one manner.

The processing units can be efficiently used by assigning processing to all the processing units as equally as possible until processing of all the slices is completed. Additionally, the entire processing time can be shortened by reducing the idle time of the processing units. Here, it is assumed that, during processing of slices, the processing units do not enter an idle state due to I/O processing (input/output processing) and the like.

It is clear that, in the case where M=<N, it is efficient to make M slices correspond to M processing units of the N processing units in a one-to-one manner so as to process each slice in each processing unit.

When M is sufficiently larger than N, if the processing time of each slice is known beforehand or the processing time of each slice can be precisely predicted to some extent, in order that the processing times be as equal as possible, M slices can be divided into N groups, the number of which is the same as the number of processing units, and the N groups are associated with the N processing units in a one-to-one manner. By doing so, each slice can be processed in each processing unit like in the case where M=<N.

However, when M is sufficiently larger than N, for example, if M is not an integral multiple of N, if the processing time of each slice is not known beforehand, or if the processing time of each slice cannot be precisely predicted, it is difficult to efficiently assign the slices to the processing units. In such a case, when data configured by a plurality of slices is processed, there is a problem that a sufficient processing speed cannot be obtained.

Therefore, an object of the present invention is to provide a decoding apparatus, a decoding method, and an editing apparatus which are novel and useful. A specific object of the present invention is to provide a decoding apparatus, a decoding method, and an editing apparatus which improve the processing speed when decoding encoded data.

### Solution to Problem

According to an aspect of the present invention, there is provided an apparatus for decoding encoded data of image data or audio data, the apparatus including: a source for providing said encoded data including a plurality of pieces of element data being able to be decoded independently, each of the plurality of pieces of element data including at least one block; first processing means for generating block information identifying a first block to be processed first among the at least one block; a plurality of second processing means for generating block information identifying a subsequent block to the first block based on an order of decoding processing in element data corresponding to the block information; a plurality of decoding means for decoding, in parallel, a block identified by referring to one piece of unreferenced block information among the generated block information; and storing means for storing the decoded block and forming decoded element data corresponding to the block.

According to the present invention, a plurality of decoding means decode element data with a block which configures the element data as a unit of processing. At the time of decoding, a block identified by referring to one piece of unreferenced block information is decoded. Additionally, block information identifying a subsequent block to the first block is generated based on an order of decoding processing in element data corresponding to the block information. For this reason, each block is decoded in a predetermined processing order according to the block information. In this way, by using a block which configures the element data as a unit of processing, compared with a case where the element data is used as a unit of processing, it is possible to reduce the possibility that some decoding means are idling because each decoding means is waiting its turn for processing and thus subjects to be processed are not provided thereto. Accordingly, the total idling time of the entire decoding means is reduced. As a result, the efficiency in using the entire decoding means is increased. Therefore, it becomes possible to improve the processing speed when decoding encoded data.

According to another aspect of the present invention, there is provided a method for decoding encoded data of image data or audio data, the method including the steps of: generating, in a processor, block information identifying a block which is processed first among at least one block which configures each of a plurality of pieces of element data included in the encoded data, the element data being able to be decoded independently, an order of decoding processing in element data corresponding to the block being given to the block; decoding, in a plurality of processors, a block which is identified by referring to one piece of generated unreferenced block information in parallel; generating, in the plurality of processors, block information identifying a subsequent block which belongs to element data configured by the decoded block in parallel based on the order of decoding processing; and repeating the step of decoding and the step of generating the block information identifying the subsequent block until all the blocks are decoded.

According to the present invention, a plurality of processors decode element data with a block which configures the element data as a unit of processing. At the time of decoding, a block identified by referring to one piece of unreferenced block information is decoded. Then, block information identifying a subsequent block which belongs to element data configured by the decoded block is generated. For this reason, each block is decoded in a predetermined processing order according to the block information. In this way, by using a block which configures the element data as a unit of processing, compared with a case where the element data is used as a unit of processing, it is possible to reduce the possibility that some decoding means are idling because each decoding means is waiting its turn for processing and thus subjects to be processed are not provided thereto. Accordingly, the total idling time of the entire decoding means is reduced. As a result, the efficiency in using the entire decoding means is increased. Therefore, it becomes possible to improve the processing speed when decoding encoded data.

### Advantageous Effects of Invention

According to the present invention, it is possible to provide a decoding apparatus, a decoding method, and an editing apparatus which improve the processing speed when decoding encoded data.

### BRIEF DESCRIPTION OF DRAWINGS

FIG. 1 is a block diagram illustrating the configuration of a decoding apparatus according to a first embodiment of the present invention.

FIG. 2 is a diagram illustrating slices and macroblocks of MPEG-2.

FIG. 3 is a diagram illustrating the functional configuration of the decoding apparatus according to the first embodiment of the present invention.

FIG. 4 is a diagram illustrating a situation where blocks are assigned to each worker processor.

FIG. 5A is a flow chart illustrating decoding processing of a main processor according to the first embodiment of the present invention.

FIG. 5B is a flow chart illustrating decoding processing of a worker processor according to the first embodiment of the present invention.

FIG. 6 is a flow chart illustrating another decoding processing of a worker processor according to the first embodiment of the present invention.

FIG. 7 is a diagram illustrating an example of slices and blocks.

FIG. 8 is a diagram illustrating a situation where blocks are assigned to each worker processor when two worker processors #0 and #1 perform decoding processing of three slices A, B, and C.

FIG. 9 is a diagram illustrating states of a queue.

FIG. 10 is a graph illustrating the speedup ratio R with respect to the number K of blocks per slice.

FIG. 11 is a diagram illustrating an example of slices and blocks.

FIG. 12 is a diagram illustrating a situation where block are assigned to each worker processor when two worker processors #0 and #1 perform decoding processing of three slices A, B, and C.

FIG. 13 is a diagram illustrating states of a queue.

FIG. 14 is a diagram illustrating a situation where blocks are assigned to each worker processor when two worker processors #0 and #1 perform decoding processing of three slices A, B, and C.

FIG. 15 is a diagram illustrating states of a queue.

FIG. 16 is a diagram illustrating an example of slices and blocks.

FIG. 17 is a diagram illustrating a situation where blocks are assigned to each worker processor when two worker processors #0 and #1 perform decoding processing of three slices A, B, and C.

FIG. 18 is a diagram illustrating states of a queue.

FIG. 19 is a diagram illustrating a situation where blocks are assigned to each worker processor when two worker processors #0 and #1 perform decoding processing of three slices A, B, and C.

FIG. 20 is a diagram illustrating states of a queue.

FIG. 21 is a diagram illustrating an example of slices and blocks.

FIG. 22 is a diagram illustrating a situation where blocks are assigned to each worker processor when two worker processors #0 and #1 perform decoding processing of three slices A, B, and C.

FIG. 23 is a diagram illustrating states of a queue.

FIG. 24 is a block diagram illustrating the hardware configuration of an editing apparatus according to a second embodiment of the present invention.

FIG. 25 is a diagram illustrating the functional configuration of the editing apparatus according to the second embodiment of the present invention.

FIG. 26 is a diagram illustrating an example of an edit screen of the editing apparatus according to the second embodiment of the present invention.

FIG. 27 is a flow chart illustrating an editing method according to the second embodiment of the present invention.

### DESCRIPTION OF EMBODIMENTS

Hereinbelow, embodiments according to the present invention will be described based on drawings.

### First embodiment

A first embodiment of the present invention is examples of a decoding apparatus and a decoding method for decoding encoded image data. In the following specific examples, an explanation will be made assuming that a decoding apparatus and a decoding method according to the first embodiment execute decoding processing of encoded image data based on MPEG-2.

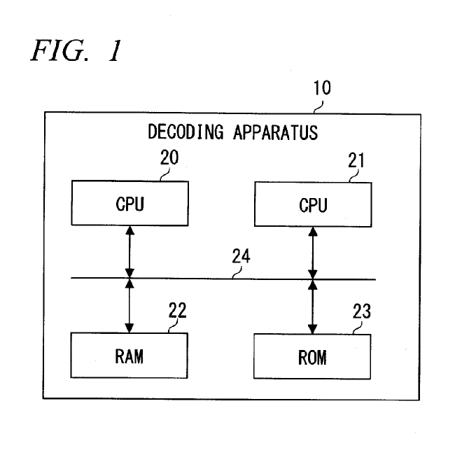

FIG. 1 is a block diagram illustrating the configuration of a decoding apparatus according to the first embodiment of the present invention.

Referring to FIG. 1, a decoding apparatus 10 includes a plurality of CPUs 20 and 21 which execute decoding processing, a RAM 22 which stores encoded image data, a ROM 23 which stores a program executed by the CPUs 20 and 21, and a bus 24 which connects the CPUs 20 and 21, the RAM 22, and the ROM 23 with each other.

The CPUs 20 and 21 load programs recorded in the ROM 23 into the RAM 22 and execute decoding processing. Although each of the CPUs 20 and 21 has one processor (CPU core), at least one of the CPUs 20 and 21 may be configured as a CPU module having two or more processors. The number of processors that the decoding apparatus 10 has may be any of 2 or more.

The RAM 22 stores, for example, encoded image data.

The encoded image data includes a plurality of slices which are elements that form the image data. A slice is configured by a plurality of blocks and is decoded in units of blocks. For simplicity of explanation, a slice and a block are defined as follows. That is, the slice is a slice of MPEG-2. Additionally, the block is a macroblock of MPEG-2.

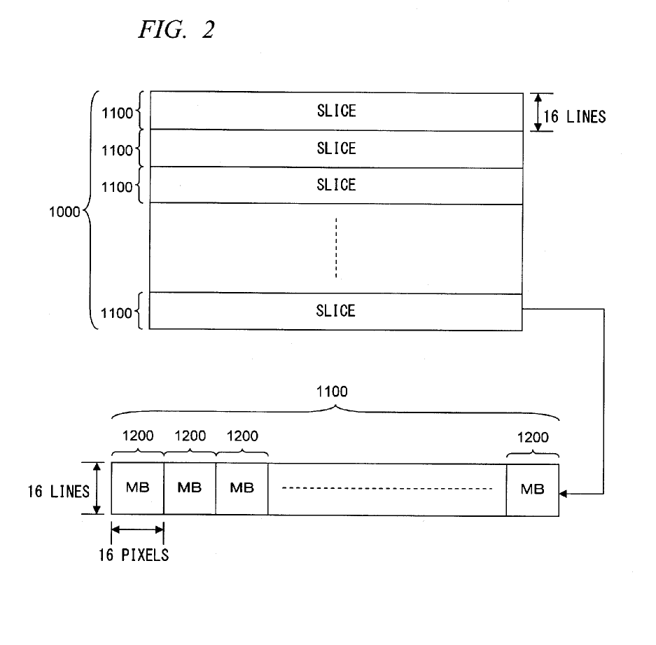

FIG. 2 is a diagram illustrating slices and macroblocks of MPEG-2.

Referring to FIG. 2, in MPEG-2, a screen 1000 is configured by slices 1100 each having a 16-line width. The slice 1100 is configured by macroblocks 1200 of 16 lines ×16 pixels.

In the first embodiment, decoding processing is assigned to a processing unit in the unit of blocks which form a slice. The data size of a block is smaller than that of a slice. By assigning decoding processing to a processing unit in the unit of blocks, assignment of decoding processing to the processing unit becomes more efficient than before. Hereinbelow, for simplicity of explanation, it is assumed that only an I (Intra) frame of encoded frames is used. It is noted that the following explanation may be similarly extended to decoding processing of a P (Predictive) frame and a B (Bidirectionally Predictive) frame.

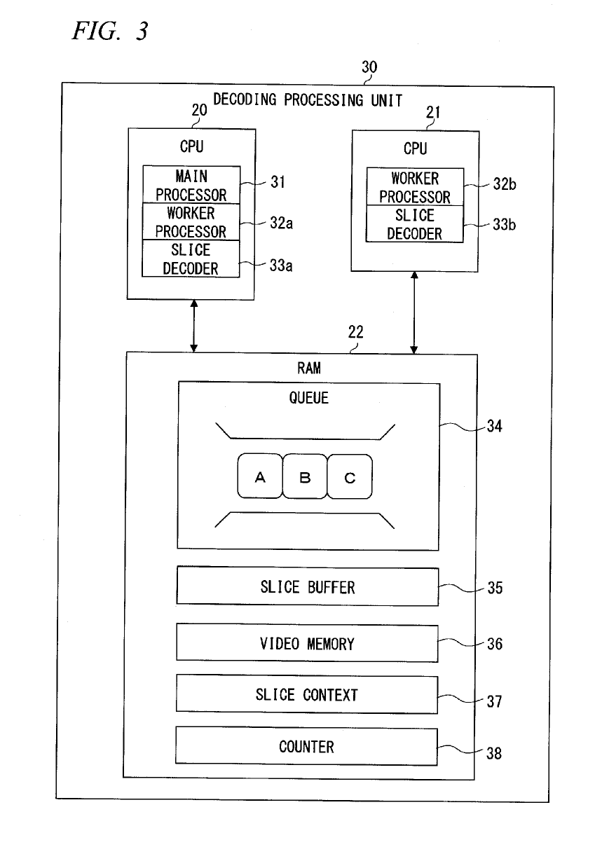

FIG. 3 is a diagram illustrating the functional configuration of the decoding apparatus according to the first embodiment of the present invention.

Referring to FIG. 3, the decoding apparatus 10 operates as a decoding processing unit 30. The CPU 20 operates as a main processor 31, a worker processor 32a, and a slice decoder 33a by a program loaded into the RAM 22. The CPU 21 operates as a worker processor 32b and a slice decoder 33b by a program loaded into the RAM 22.

The main processor 31 executes processing required to start decoding processing of blocks of each slice. Although the main processor 31 is assigned to the CPU 20 in FIG. 3, the main processor 31 may be assigned to the CPU 21. The worker processors 32a and 32b assign blocks to the slice decoders 33a and 33b and make the slice decoders 33a and 33b execute decoding processing of the assigned blocks.

The slice decoders 33a and 33b execute decoding processing of the blocks assigned by the worker processors 32a and 32b. Each worker processor and each slice decoder have a one-to-one correspondence relationship. That is, the worker processor 32a has a correspondence relationship with the slice decoder 33a, assigns blocks to the slice decoder 33a, and makes the slice decoder 33a execute decoding processing of the assigned blocks. Additionally, the worker processor 32b has a correspondence relationship with the slice decoder 33b, assigns blocks to the slice decoder 33b, and makes the slice decoder 33b execute decoding processing of the assigned blocks. Although it is assumed that the slice decoder is realized by software in this example, it may be realized by hardware.

The RAM 22 has a queue 34, a slice buffer 35, a video memory 36, a slice context 37, and a counter 38.

A wrapper block is stored in the queue 34. The wrapper block includes information on a block to be processed. An encoded slice is stored in the slice buffer 35. The decoded slice is stored in the video memory 36. Information on the state of decoding processing of a slice is stored in the slice context 37. Specifically, the information on the state of decoding processing of a slice includes information on the starting position of a code of the slice and information on the position on the video memory 36 of an output destination of the slice. The value stored in the counter 38 is initialized at the start of decoding processing and is updated whenever decoding processing of each slice is completed.

More specifically, decoding processing by the slice decoders 33a and 33b is performed as follows. The information on the starting position of the code of a slice and the information on the position on the video memory 36 of the output destination of the slice are given to the slice context 37, and the slice context 37 is initialized. The slice decoders 33a and 33b decode blocks sequentially one at a time from the first block of the slice according to the given slice context 37 and output the decoded blocks to the video memory 36. The slice decoders 33a and 33b update the slice context 37 whenever a block of the slice is decoded.

<Blocks Which Form a Slice>

Although slices of MPEG-2 are data which can be independently decoded, blocks (macroblocks) belonging to the same slice have the following three dependencies except for the first block of the slice.

(1) DC prediction: DC components of a current block are predicted from a block which is immediately before the current block in raster order.

(2) Quantization scale: the quantization scale of a block can be omitted when using the same quantization scale as the quantization scale of a block which is immediately before the block in raster order.

(3) Starting position of code: the starting position of a code of a certain block cannot be determined unless all the codes of the preceding blocks are decoded.

The DC prediction, the quantization scale, and the starting position of the code are stored as a slice context.

In order to decode each slice of an encoded stream, information (chroma sub-sampling, DC precision, a quantization matrix, and the like) common to slices, which is included in an MPEG header (a sequence header, a picture header, or the like), is required. For simplicity of explanation, it is assumed that this information is analyzed before a slice is decoded and the information is implicitly given to the slice decoders.

The starting position of the code of each slice is signaled by a slice header in the stream. By finding the slice header from the stream, the starting position of the code of each slice can be obtained. However, the starting position of the code of a block in a slice cannot be known in advance before decoding processing is performed.

In the first embodiment of the present invention, a slice S is divided into K blocks. K blocks obtained by dividing one slice S are referred to as S^{0/K}, S^{1/K}, . . . , and S^{(K-1)/K}. It is noted that any integer may be selected as the number K of blocks if it is greater than or equal to one, but it is preferable to take the following points into consideration.

Although any method for dividing a slice into blocks can be used, it is necessary to determine the division width appropriately. Since the division width is related to the processing time of a block, if the division width is too large, it becomes difficult to equally assign processing to respective worker processors. In contrast, if the division width is too small, overhead due to access to a queue, storing and restoring a processing state of a slice (a slice context), cache miss in processing of a slice, and the like is increased.

<Dependency of a Block (Wrapper Block)>

There is dependency (sequentiality) among K blocks S^{0/K}, S^{1/K}, . . . , S^{(K-1)/K} that form one slice S. The dependency means that processing of one of two blocks is completed before starting processing of the other of the blocks. The dependency is expressed as S^{0/K}->S^{1/K}-> . . . S^{k/K}->S^{(k+1)/K} (k=0, . . . , K−1) indicates that processing of the block S^{k/K} is completed before starting processing of the block S^{(k+1)/K}.

The wrapper block has information on the dependency of processing of blocks of each slice S and particularly includes information for identifying a block to be processed. When a wrapper block W^{k/K} of each slice S is fetched from the queue 34, the following processing is executed.

In the case of 0=<k <K−1: the block S^{k/K} is processed. Then, a wrapper block W ^{(k+1)/K} regarding the block S^{(k+1)/K} which is to be processed next is added to the queue.

In the case of k=K−1: the block S^{k/K} is processed and decoding processing of the slice S is completed.

In the initial state of the decoding processing, a first wrapper block W^{0/K} of each slice is generated and is stored in the queue 34. The worker processors 32a and 32b fetch the wrapper block W^{k/K} of the slice S from the queue 34, perform processing of the block S ^{k/K} of the slice S designated by the wrapper block W^{k/K}, and then add to the queue the wrapper block W^{(k+1)/K} concerning processing of the next block S^{(k+1)/K} of the slice S. In this way, the dependency that processing of the block S^{k/K} of the slice S is completed before starting processing of the block S^{(k+1)/K} of the slice S is guaranteed.

<Queue Control >

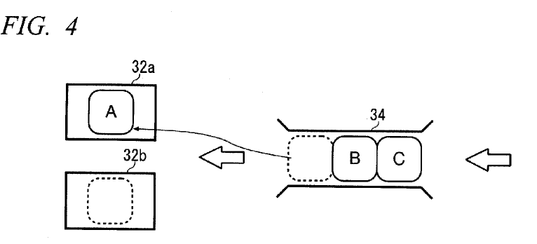

FIG. 4 is a diagram illustrating a situation where wrapper blocks are assigned to each worker processor. Referring to FIG. 4, wrappers block waiting to be processed are placed in the queue 34, and the worker processors 32a and 32b fetch wrapper blocks from the queue 34 and process the fetched wrapper blocks.

In the example shown in FIG. 4, the queue 34 can store three wrapper blocks. When a wrapper block is added to the queue 34, the wrapper block is added to the end of a line formed by wrapper blocks. Additionally, when a wrapper block is fetched from the queue 34, the wrapper block at the head of the line formed by the wrapper blocks is fetched. However, priorities may be associated with wrapper blocks and the wrapper blocks stored in the queue 34 may be fetched in descending order of priorities associated with the wrapper blocks. FIG. 4 shows a situation where the block A at the head of the wrapper block line is fetched in a state where three wrapper blocks A, B, and C are stored in the queue 34 and the fetched wrapper block A is processed by the worker processor 32a.

When a plurality of worker processors access the queue 34 simultaneously in order to fetch a wrapper block from the queue 34 or add a wrapper block to the queue 34, the access is mutually exclusive. That is, only access from one worker processor is permitted at a time, and the other worker processors cannot access the queue 34. By this control, since two or more worker processors cannot fetch the same wrapper block from the queue 34 and process the wrapper block, the consistency of the state of the queue 34 is maintained.

<Priorities in Processing Blocks>

By giving indices of priorities to blocks, which are obtained by dividing a slice, and preferentially processing a block with a higher priority when blocks each corresponding to each of a plurality of slices are stored in the queue 34, assignment of processing to the worker processors 32a and 32b tends to be more efficient. In the first embodiment of the present invention, three priorities P₀, P₁, and P₂ are defined. Each priority is assigned to each block.

The priority P₀ is an index based on the progress ratio of processing of blocks in a slice. The priority P₀(S^{k/K}) of the block S^{k/K} is defined in Equation (1) as a ratio of the processing time of subsequent blocks including the block S^{k/K} and the processing time of the entire slice S.

$$\begin{matrix}[ Math . 1 ] & \\ {P}_{0} ( {S}^{k / K} ) = \frac{{\sum }_{j = k}^{K - 1} T ( {S}^{j / K} )}{T ( S )} & ( 1 )\end{matrix}$$

In Equation (1), T(S^{j/K}) is the processing time of the block S^{j/K} and T(S) is the processing time of the entire slice S. In practice, even if T(S^{j/K}) and T(S) are unknown, the priority P₀ can be calculated if the ratio can be precisely predicted to some extent. Equation (1) is equivalent to Equation (2).

[Math.2]

P₀(S^{k/K})=1−(progress ratio) (2)

Equation (2) indicates that the block of a slice with a low progress ratio is preferentially processed. Assuming that the processing times of respective blocks are the same, when processing of k blocks which include block S^{0/K} to block S^{k-1/K} among K blocks has been completed, the progress ratio is expressed as k/K. Accordingly, the priority P₀ defined by Equation (3) is obtained from Equation (2).

[Math.3]

P₀(S^{k/K})=1−k/K (3)

The priority P₁ is an index based on the processing time of unprocessed blocks in a slice. The priority P₁(S^{k/K}) of the block S^{k/K} is defined in Equation (4) as the processing time of subsequent blocks including the block S^{k/K}.

$$\begin{matrix}[ Math . 4 ] & \\ {P}_{1} ( {S}^{k / K} ) = {\sum }_{j = k}^{K - 1} T ( {S}^{j / K} ) & ( 4 )\end{matrix}$$

In Equation (4), T(S^{j/K}) is the processing time of the block S^{j/K}.

When T(S^{j/K}) is unknown, T(S^{j/K}) may be predicted from, for example, the processing time of the blocks the processing of which is completed. Equation (4) indicates that a block of a slice with a long (predicted) remaining processing time is processed preferentially.

The priority P₂ is an index based on the timing at which a wrapper block corresponding to a block is added to the queue 34. The priority P₂(S^{k/K}) of the block S^{k/K} is defined in Equation (5) as a time t^{k/K} at which the wrapper block corresponding to the block S^{k/K} is added to the queue 34.

[Math.5]

P₂(S^{k/K})=t^{k/K} (5)

By preferentially performing processing of a block of the same slice as the slice to which the block processed last belongs according to Equation (5), the cache efficiency is increased and the processing speed is improved.

When the division width of a block (the processing time of a block) is large to some extent and a plurality of blocks having the same priority P₀ exist in the entire slice, by introducing, for example, the priorities P₁ and P₂, processing of blocks can be more equally assigned to the worker processors 32a and 32b.

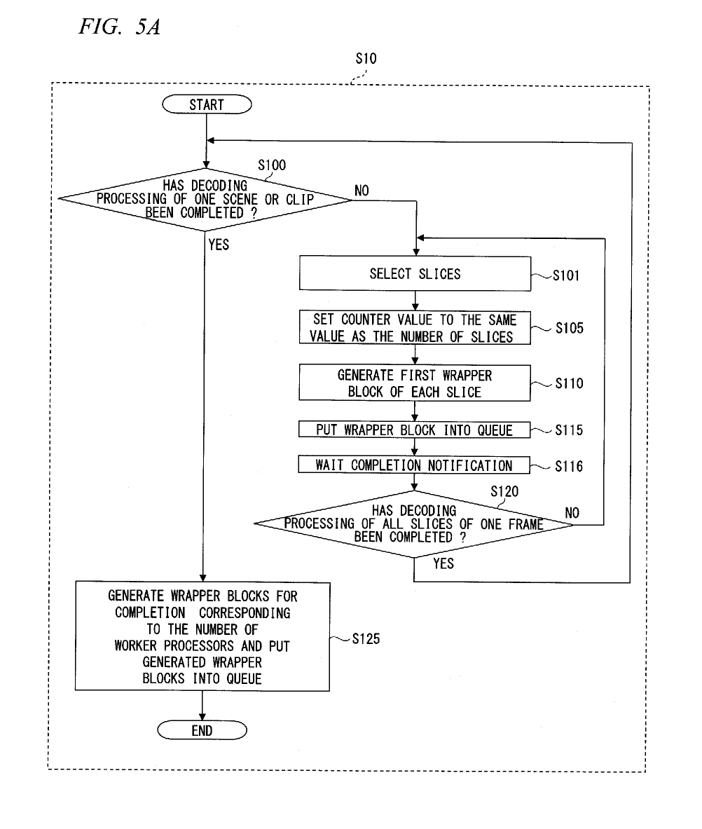

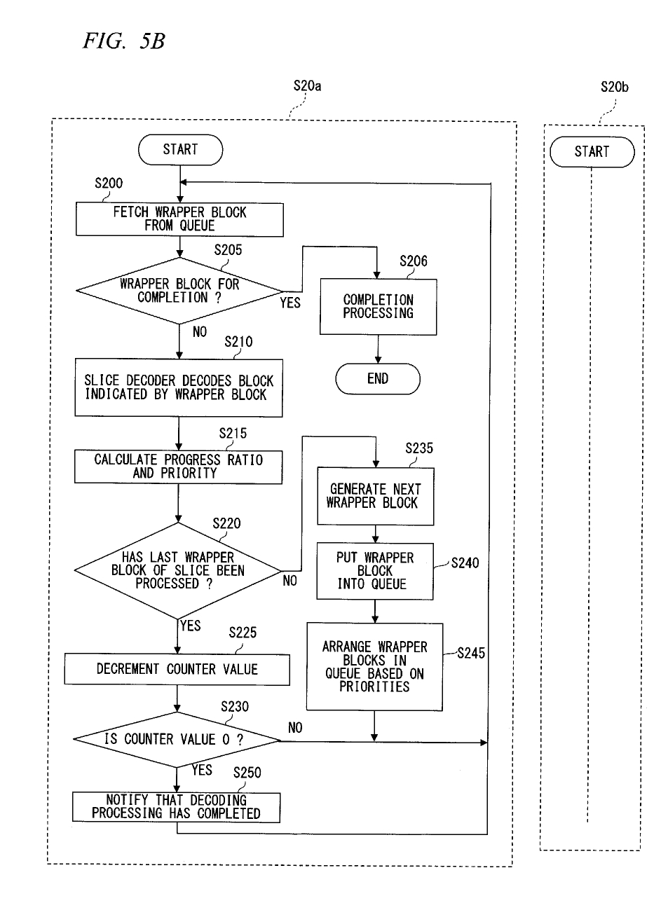

FIG. 5A is a flow chart illustrating decoding processing of the main processor 31 according to the first embodiment of the present invention.

Referring to FIG. 5A, the main processor 31 executes processing S10. The processing S10 includes steps S100, S101, S105, S110, S115, S116, S120, and S125 described below.

First, in step S100, processing is branched according to a result of determination on whether or not decoding processing of one scene or clip has been completed.

When decoding processing of one scene or clip has not been completed, in step S101, the main processor 31 selects slices to be processed in one frame which forms one scene or clip.

Then, in step S105, the main processor 31 stores the same value as the number of the slices to be processed in the counter 38.

Then, in step S110, the main processor 31 generates a first wrapper block of each slice. At this time, wrapper blocks, the number of which is the same as the number of the slices, are generated.

A slice context is included in a generated wrapper block. Information on the position on the slice buffer 35 at which a code of the slice to be decoded is stored, information on the position on the video memory 36 of an output destination of the slice, the progress ratio of decoding processing of the slice to which the wrapper block belongs, and the priorities are included in the slice context.

The position on the slice buffer 35 indicates the starting position of a block of a slice to be decoded. The position on the video memory 36 indicates the position at which a decoded block is stored.

The progress ratio is calculated, for example, as (the number of decoded blocks)/(the number of all the blocks included in the slice). Alternatively, the progress ratio may be calculated as (the cumulative value of code lengths of decoded blocks)/(the sum of code lengths of all the blocks included in the slice).

The number of all the blocks included in the slice or the sum of code lengths of all the blocks included in the slice, which is used to calculate the progress ratio, is stored in the slice context 37 prior to starting decoding processing of the entire slice. Whenever a block is decoded, the number of decoded blocks or the cumulative value of code lengths of decoded blocks is updated and is stored in the slice context 37.

The priority is defined as a value obtained by subtracting the progress ratio from one. This priority is equivalent to the priority P₀. In this example, only the priority P₀ is used, but the priority P₁ and/or the priority P₂ may be used in addition to the priority P₀.

In step S110, since the progress ratio of each slice is zero, the priority associated with a first wrapper block of each slice is one. When the first wrapper block of each slice is fetched from the queue 34, each wrapper block is fetched in order of being put into the queue 34.

Then, in step S115, the main processor 31 puts the generated wrapper blocks into the queue 34.

Then, in step S116, the main processor 31 waits for a notification from the worker processors 32a and 32b which indicates completion of decoding processing of the slices selected in step S101.

When completion of decoding processing of the slices selected in step S101 is notified from the worker processors 32a and 32b, the processing proceeds to step S120. In step S120, processing is branched according to a result of determination on whether or not decoding processing of all the slices of one frame has been completed. If decoding processing of other slices is subsequently to be performed, processing from step S101 is executed again. If decoding processing of all the slices of one frame has been completed, processing from step S100 is executed again.

When decoding processing of one scene or clip has been completed in step S100, in step S125, the main processor 31 generates wrapper blocks for completion, the number of which is the same as the number of worker processors 32a and 32b, and puts them into the queue 34. Since information specifying completion, for example, is included in the wrapper blocks for completion, it is possible to distinguish the wrapper blocks for completion from the wrapper blocks generated in step S110. After putting the wrapper blocks for completion into the queue 34, the main processor 31 completes processing S10.

FIG. 5B is a flow chart illustrating decoding processing of the worker processors 32a and 32b according to the first embodiment of the present invention.

Referring to FIG. 5B, the worker processors 32a and 32b execute processing S20a and S20b, respectively, and the worker processors 32a and 32b execute the processing S20a and S20b in parallel. The processing S20a includes steps S200, S205, S206, S210, S215, S220, S225, S230, S235, S240, S245, and S250 described below. Since the processing S20b is the same as the processing S20a, illustration of the detailed flow is omitted.

First, although not shown, when there is no wrapper block in the queue 34, the worker processors 32a and 32b wait until a wrapper block is added to the queue 34.

When there is a wrapper block in the queue 34, in step S200, the worker processors 32a and 32b fetch a wrapper block from the head of the queue 34.

Subsequently, the worker processors 32a and 32b check whether or not the wrapper block fetched from the queue 34 in step S200 is a wrapper block for completion. If the wrapper block fetched from the queue 34 in step S200 is a wrapper block for completion, in step S206, the worker processors 32a and 32b perform completion processing, such as releasing a region of the RAM 22 that are used by the worker processors themselves, and complete the processing S20a and S20b.

If the wrapper block fetched from the queue 34 in step S200 is not a wrapper block for completion, in step S210, the worker processors 32a and 32b make the slice decoders 33a and 33b perform decoding processing of a block to be processed which is indicated by the wrapper block fetched from the queue 34.

Specifically, in step S210, the following processing is performed. A slice context is included in a wrapper block. As described above, information on the position on the slice buffer 35 in which a code of a slice to be decoded is stored and information on the position on the video memory 36 of an output destination of the slice are included in the slice context. The worker processors 32a and 32b give such pieces of information to the slice decoders 33a and 33b.

The slice decoders 33a and 33b read data of the encoded slice from the slice buffer 35 in units of bits or bytes and perform decoding processing of the read data. When decoding processing of the block is completed, the slice decoders 33a and 33b store data of the decoded block in the video memory 36 and update the slice context 37.

Information on the position on the video memory 36 of the output destination of a slice, which is given to the slice decoders 33a and 33b by the worker processors 32a and 32b, indicates the position on the video memory 36 corresponding to the position of the slice in the frame and the position of the block in the slice. The slice decoders 33a and 33b store the data of the decoded blocks in the position indicated by the foregoing information. When decoding processing of all the blocks included in all the slices forming one frame is completed, each block stored in the video memory 36 forms the decoded slice corresponding to each encoded slice.

Then, in step S215, the worker processors 32a and 32b calculate the progress ratio of a slice to which the decoded block belongs and the priority based on the slice context 37. As described above, the progress ratio is calculated as, for example, (the number of decoded blocks)/(the number of all the blocks included in the slice) or (the cumulative value of code lengths of decoded blocks)/(the sum of code lengths of all the blocks included in the slice). The priority is calculated as a value obtained by subtracting the progress ratio from one.

Then, in step S220, processing is branched according to a result of determination on whether or not the last wrapper block of the slice has been processed. The determination on whether or not the last wrapper block of the slice has been processed can be performed by using the value of the progress ratio. That is, if the progress ratio is smaller than one, the last wrapper block of the slice has not been processed yet. In contrast, if the progress ratio is one, the last wrapper block of the slice has been processed.

When the last wrapper block of the slice has been processed, in step S225, the worker processors 32a and 32b decrement the value of the counter 38 by one. When a plurality of worker processors access the counter 38 simultaneously, the access is mutually exclusive.

Then, in step S230, the worker processors 32a and 32b check the value of the counter 38. Whenever the last block of each slice is decoded, in step S225, the value of the counter 38, which was set to the same value as the number of slices in step S105, is decremented by one. Accordingly, if the value of the counter is not 0, there is a slice for which the decoding processing has not been completed, and thus processing from step S200 is executed again. Additionally, if the counter value becomes zero, processing of wrapper blocks of all the slices has been completed, and thus, in step S250, the worker processors 32a and 32b notify the main processor 31 of completion of decoding processing of the slices selected in step S101 of FIG. 5A. Then, processing from step S200 is executed again.

When the last wrapper block of the slice has not been processed yet in step S220, in step S235, the worker processors 32a and 32b generate a wrapper block including information identifying the subsequent block to the block decoded in step S210, which is a block belonging to the same slice as the slice to which the block decoded in step S210 belongs.

A slice context is included in a generated wrapper block. This slice context includes information on the position on the slice buffer 35 at which a code of the slice to be decoded is stored, information on the position on the video memory 36 of an output destination of the slice, and the progress ratio of decoding processing of the slice to which the wrapper block belongs as well as the priority that are calculated in step S215, which are obtained from the slice context 37 updated after decoding processing.

Then, in step S240, the worker processors 32a and 32b put the generated wrapper block into the queue 34.

Then, in step S245, the worker processors 32a and 32b arrange wrapper blocks within the queue 34 including the wrapper blocks added to the queue 34 in step S240 in descending order of the priorities associated with the respective wrapper blocks. Then, processing from step S200 is executed again.

Encoded image data of one whole frame including slices is decoded as follows. For example, it is assumed that one frame is formed by U slices and numbers of 1, 2, . . . , U are given to each slice sequentially from the top of the frames. Decoding processing is executed with V (V=<U) slices or less as a unit. For example, V slices of first to V-th slices are selected as subjects to be processed (corresponding to step S101 of FIG. 5A) and are processed according to the flow chart shown in FIG. 5A. After decoding processing of the V slices is completed, V slices of (V+1)-th to 2 V-th slices are selected as subjects to be processed (corresponding to step S101 of FIG. 5A) and are processed according to the flow chart shown in FIG. 5A. When the number of remaining slices becomes V or less, all of the remaining slices are selected as subjects to be processed (corresponding to step S101 of FIG. 5A) and are decoded according to the flow chart shown in FIG. 5A. As described above, encoded image data of one whole frame is decoded.

In the case of performing decoding processing of encoded moving image data, when decoding processing of encoded image data of one whole frame has been completed, decoding processing of encoded image data of the whole frame related to the next frame is started. The above-described processing is an example of executable processing, and thus it is not limited to the processing described above. For example, since decoding processing of the respective slices can be executed independently, decoding processing is not necessarily executed with slices, which are continuously arranged within a frame, as a unit.

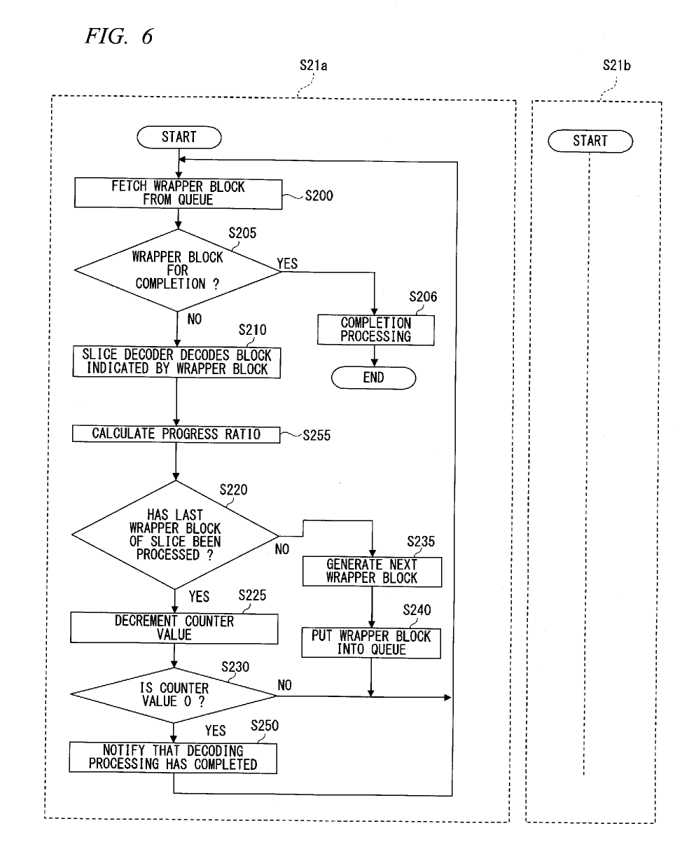

FIG. 6 is a flow chart illustrating another decoding processing of the worker processors 32a and 32b according to the first embodiment of the present invention.

Referring to FIG. 6, another decoding method according to the first embodiment does not use the priority. This point is different from the previous flow chart shown in FIG. 5B. Accordingly, when a wrapper block is fetched from the queue 34, each wrapper block is fetched in order of being put into the queue 34. In FIG. 6, the same step number is given to the same processing as the processing shown in FIG. 5B, and thus the explanation thereof is omitted hereinbelow and only points different from those of the flow chart shown in FIG. 5B will be described.

Although the progress ratio and the priority of a slice are calculated in step S215, since the priority is not used in the flow chart shown in FIG. 6, only the progress ratio is calculated in step S255. Additionally, in the flow chart shown in FIG. 6, processing of step S245 of FIG. 5B is not executed.

<Example of Decoding Processing>

The behavior of a worker processor (arbitration when a plurality of worker processors access a queue simultaneously, the processing time of a block, and the like) is non-deterministic due to factors such as occurrence of interruption, and the behavior may change depending on implementation. In the first embodiment, an example of typical decoding processing in which a queue is used is shown. Moreover, for simplicity of explanation, it is assumed that the time required for access to a queue can be ignored.

An example of decoding processing of slices in the case of M=3 and N=2 is shown below. A slice processing method shown in the following example is not necessarily optimal. Hereinafter, for simplicity of explanation, wrapper blocks and blocks obtained by dividing a slice are simply described as blocks without being distinguished.

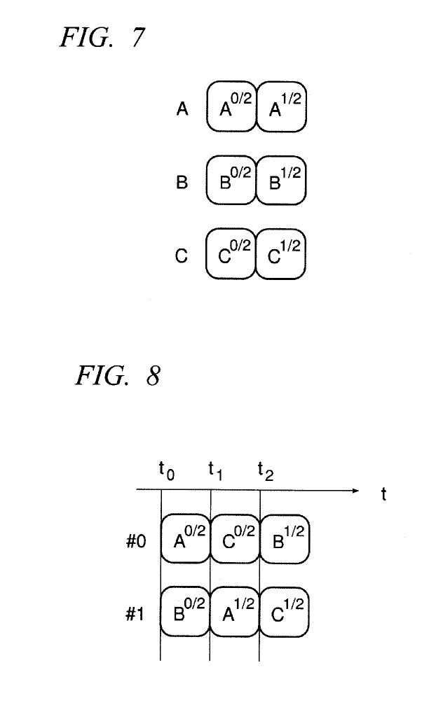

FIG. 7 is a diagram illustrating an example of slices and blocks. Referring to FIG. 7, three slices A, B, and C can be divided into two blocks with the same division width, which need the same processing time. For example, the slice A can be divided into a block A^{0/2} and a block A^{1/2}. The reference numeral given to the upper right of each block indicates the order of processing of each block. For example, for the block A^{0/2}, “0/2” indicates the order of processing. “2” of “0/2” indicates the total number of blocks. The block A^{0/2} is processed earlier than the block A^{1/2}.

The slice B can be divided into a block B^{0/2} and a block B^{1/2}. The block B^{0/2} is processed earlier than the block B^{1/2}. The slice C can be divided into a block C^{0/2} and a block C^{1/2}. The block C^{0/2} is processed earlier than the block C^{1/2}.

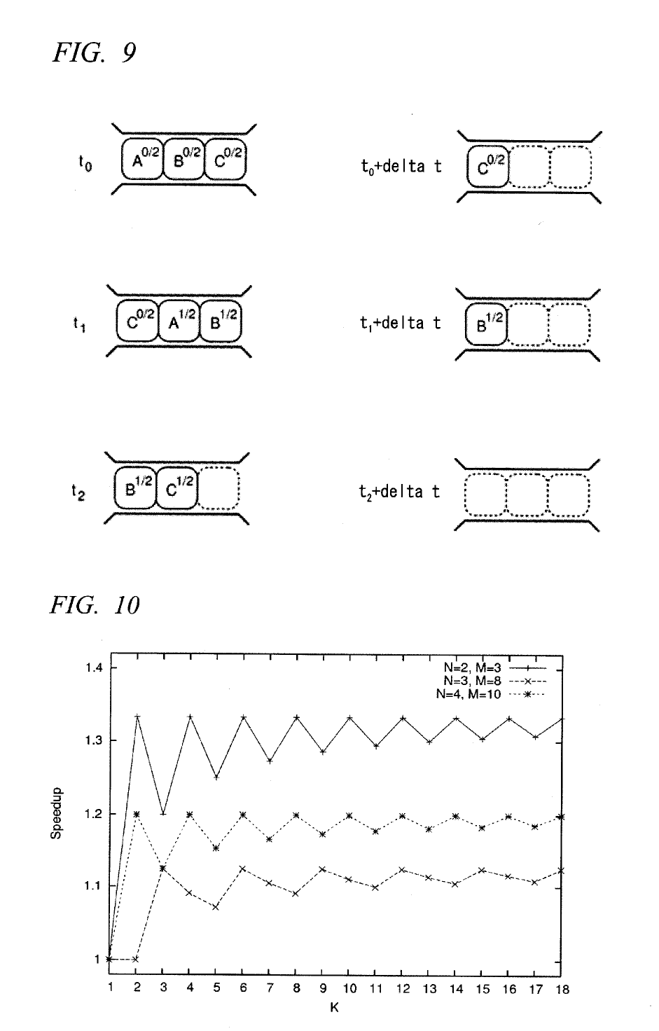

FIG. 8 is a diagram illustrating a situation where blocks are assigned to each worker processor when two worker processors #0 and #1 process the three slices A, B, and C. FIG. 9 is a diagram illustrating states of the queue.

The first blocks A^{0/2}, B^{0/2}, and C^{0/2} of all the slices are added to the queue at time t=t₀ (corresponding to step S115 of FIG. 5A).

The head block A^{0/2} and the next block B^{0/2} are fetched from the queue at time t=t₀+delta t (immediately after time t=t₀), and processing of the block A^{0/2} is assigned to the worker processor #0 and processing of the block B^{0/2} is assigned to the worker processor #1 (corresponding to step S205 of FIG. 6). When the processing of the blocks is assigned to the respective worker processors, the respective worker processors start the processing in parallel (corresponding to step S210 of FIG. 6).

After the processing of the block A^{0/2} and the block B^{0/2} is completed at time t=t₁, the block A^{1/2} to be processed after the block A^{0/2} and the block B^{1/2} to be processed after the block B^{0/2} are added to the queue (corresponding to step S240 of FIG. 6). The block C^{0/2} which was the tail block at time t=t₀ becomes the head block at time t=t₁, and the block A^{1/2} and the block B^{1/2} are added after the block C^{0/2}.

The head block C^{0/2} and the next block A^{1/2} are fetched from the queue at time t=t₁+delta t, and processing of the block C^{0/2} is assigned to the worker processor #0 and processing of the block A^{1/2} is assigned to the worker processor #1 (corresponding to step S205 of FIG. 6). When the processing of the blocks is assigned to the respective worker processors, the respective worker processors perform the processing of the respective blocks in parallel (corresponding to step S210 of FIG. 6).

After the processing of the block C^{0/2} and the block A^{1/2} is completed at time t=t₂, the block C^{1/2} to be processed after the block C^{0/2} is added to the queue (corresponding to step S240 of FIG. 6). Since the processing of the block A^{1/2} has been completed, processing of the slice A is completed. The block B^{1/2} which was the tail block at time t =t₁ becomes the head block at time t=t₂, and the block C^{1/2} is added after the block B _{1/2}.

The head block B^{1/2} and the next block C^{1/2} are fetched from the queue at time t=t₂+delta t, and processing of the block B^{1/2} is assigned to the worker processor #0 and processing of the block C^{1/2} is assigned to the worker processor #1 (corresponding to step S205 of FIG. 6). When the processing of the blocks is assigned to the respective worker processors, the respective worker processors perform the processing of the respective blocks in parallel (corresponding to step S210 of FIG. 6).

After the processing of the block B^{1/2} and the block C^{1/2} is completed, processing of the slice B and the slice C is completed. Since the processing of the slice A is completed earlier than this point of time, processing of all the slices is completed when the processing of the block B^{1/2} and the block C^{1/2} has been completed.

In this example, all the slices are equally divided into blocks with the same processing time, and the total number of blocks is a multiple of the number of worker processors. Accordingly, as shown in FIG. 8, processing of blocks can be equally assigned to two worker processors.

<Decoding Processing Performance>

Processing performance by the decoding method of the first embodiment will be described below through an example. In the following explanation, it is assumed that processing of a worker processor is executed by a thread. Additionally, it is assumed that the relationship between the number N of worker processors and the number M of slices is M>=N, execution times (predicted values of the execution times) of all the slices are equal, and the times are T. In the example, all the slices are equally divided into K blocks, and each block needs the execution time of T/K. For simplicity of explanation, it is assumed that overhead, such as a time required for switching of processing by worker processors and an access time to a queue, can be ignored.

Typically, a time quantum assigned to a worker processor is from about several tens of milliseconds to several hundreds of milliseconds. A video frame typically consists of 30 frames per second, and it is necessary to decode one frame at least in 1/30th of a second, that is, about 33 milliseconds in order to playback images in real time. In a practical application such as a video editing system, a decoding processing time that is shorter than 33 milliseconds is required to playback a plurality of video clips simultaneously or to apply video effects and transitions.

As a reference example, it is considered to execute processing of M slices by M worker processors when the time quantum is equal to or longer than the processing time T of one slice. The time quantum is also called a time slice and means an interval at which OS switches execution of processing by worker processors. First, processing of slices, the number of which is the same as the number N of processors, is started by worker processors corresponding to the respective slices.

N slices are processed in parallel, and the processing is completed before the time quantum is exhausted. When processing of the N slices is completed, another N slices are similarly processed in parallel until the number of remaining slices becomes less than N.

In the following discussion, following symbols (P1 and P2) are used. The symbol (P1) indicates the maximum integer that does not exceed X, and the symbol (P2) indicates the minimum integer of not less than X.

[Math.6]

└S┘ (P1)

[Math.7]

┌X┐ (P2)

In the case where M can be divided by N without a remainder, processing of all the slices is completed if parallel processing is performed M/N times. In the case where M cannot be divided by N without a remainder, after parallel processing is performed D (Equation (6)) times, E (Equation (7)) slices are finally processed in parallel. In the last parallel processing, F (Equation (8)) worker processors to which slices are not assigned are idling.

$$\begin{matrix}[ Math . 8 ] & \\ D = ⌊ \frac{M}{N} ⌋ & ( 6 ) \\ [ Math . 9 ] & \\ E = M - N ⌊ \frac{M}{N} ⌋ & ( 7 ) \\ [ Math . 10 ] & \\ F = N - ( M - N ⌊ \frac{M}{N} ⌋ ) & ( 8 )\end{matrix}$$

In the reference example, the total processing time T₁ is represented by Equation (9).

$$\begin{matrix}[ Math . 11 ] & \\ {T}_{1} = ⌈ \frac{M}{N} ⌉ T & ( 9 )\end{matrix}$$

In the present invention, processing of MK blocks can be executed in parallel by N worker processors while maintaining the dependencies between the blocks. Since the processing time of one slice is T and one slice is configured by K blocks, the processing time of each block is T/K. Since each worker processor corresponds to one CPU, switching between worker processors does not occur during processing of slices. By replacing M with MK and T with T/K in Equation (9) used in the discussion of the performance of the reference example, the total processing time T₂ of the present invention can be calculated as shown in Equation (10).

$$\begin{matrix}[ Math . 12 ] & \\ {T}_{2} = ⌈ \frac{MK}{N} ⌉ \frac{T}{K} & ( 10 )\end{matrix}$$

A speedup ratio R which is an index for comparing the processing performance of the reference example with the processing performance of the present invention is defined by Equation (11).

$$\begin{matrix}[ Math . 13 ] & \\ R = \frac{{T}_{1}}{{T}_{2}} = K \frac{⌈ \frac{M}{N} ⌉}{⌈ \frac{MK}{N} ⌉} & ( 11 )\end{matrix}$$

When the processing time T₁ of the reference example is equal to the processing time T₂ of the present invention, R=1. Accordingly, the processing performance of the reference example is equal to the processing performance of the present invention. Additionally, when the processing time T₁ of the reference example becomes longer than the processing time T₂ of the present invention, R>1. Accordingly, the processing performance of the present invention exceeds the processing performance of the reference example.

Hereinbelow, the relationship between K and the speedup ratio R is shown for some combinations of N and M. FIG. 10 is a graph illustrating the speedup ratio R with respect to the number K of blocks per slice.

At the time of K=1, the speedup ratio becomes one. Accordingly, the processing performance of the reference example is equal to that of the present invention. When the total block number MK is a multiple of N, the speedup ratio R is its maximum value of Rₘₐₓ (Equation (12)).

$$\begin{matrix}[ Math . 14 ] & \\ {R}_{m ax} = ⌈ \frac{M}{N} ⌉ \frac{N}{M} & ( 12 )\end{matrix}$$

In the case of N=2 and M=3 and in the case of N=4 and M=10, the speedup ratio exceeds one when K becomes two or more. Accordingly, the processing performance of the present invention exceeds the processing performance of the reference example. In the case of N=3 and M=8, the speedup ratio exceeds one when K becomes three or more. Accordingly, the processing performance of the present invention exceeds the processing performance of the reference example. Additionally, the larger K becomes, that is, the finer the division of a slice becomes, the more closely the speedup ratio R approaches Rₘₐₓ.

In this way, in the present invention, when each slice can be divided into blocks, the number of which is larger than or equal to a predetermined number, assignment of processing to worker processors becomes efficient and the processing speed is improved compared to the reference example.

<Example of Slice Decoding Processing Using Priority P₀>

As the decoding processing method according to the first embodiment, an example of decoding processing when the priority P₀ is not used and an example of decoding processing when the priority P₀ is used are shown. For simplicity of explanation, it is assumed that a time required for access to a queue and a time required for rearrangement of blocks can be ignored.

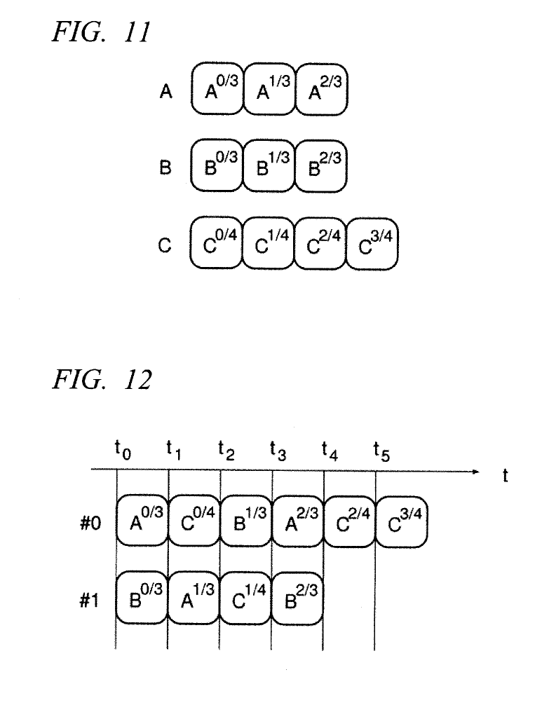

FIG. 11 is a diagram illustrating an example of slices and blocks. Referring to FIG. 11, there are three slices A, B, and C. The slices A and B are configured by three blocks, and the slice C is configured by four blocks. The division width of the blocks (processing times of the blocks) of the slices A, B, and C is equal. Accordingly, the processing time of the slice C is longer than the processing time of the slices A and B.

The slice A is divided into a block A^{0/3}, a block A^{1/3}, and a block A^{2/3}. Each block of the slice A is processed in the order of the block A^{0/3}, the block A^{1/3}, and the block A^{2/3}. The slice B is divided into a block B^{0/3}, a block B^{1/3}, and a block B^{2/3}. Each block of the slice B is processed in the order of the block B^{0/3}, the block B^{1/3}, and the block B^{2/3}. The slice C is divided into a block C^{0/4}, a block C^{1/4}, a block C^{2/4}, and a block C^{3/4}. Each block of the slice C is processed in the order of the block C^{0/4}, the block C^{1/4}, the block C^{2/4}, and the block C^{3/4}.

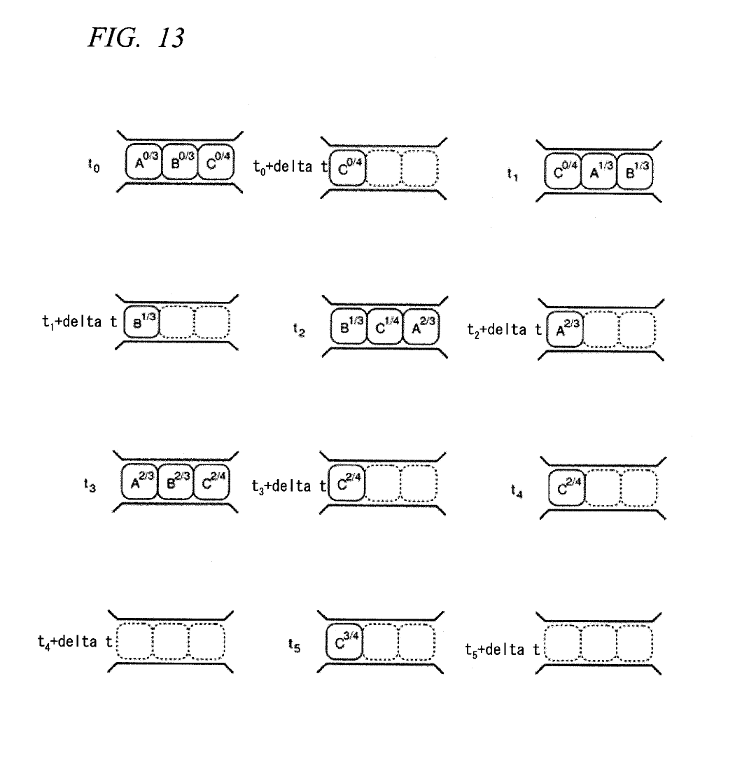

FIG. 12 is a diagram illustrating a situation where blocks are assigned to each worker processor when two worker processors #0 and #1 process the three slices A, B, and C. FIG. 13 is a diagram illustrating states of the queue. In the example shown in FIGS. 12 and 13, the priority P₀ is not used.

The first blocks A^{0/3}, B^{0/3}, and C^{0/4} of all the slices are added to the queue at time t=t₀ (corresponding to step S115 of FIG. 5A).

The head block A^{0/3} and the next block B^{0/3} are fetched from the queue at time t=t₀+delta t, and processing of the block A^{0/3} is assigned to the worker processor #0 and processing of the block B^{0/3} is assigned to the worker processor #1 (corresponding to step S205 of FIG. 6). When the processing of the blocks is assigned to the respective worker processors, the respective worker processors start the processing in parallel (corresponding to step S210 of FIG. 6).

After the processing of the block A^{0/3} and the block B^{0/3} is completed at time t=t₁, the block A^{1/3} to be processed after the block A^{0/3} and the block B^{1/3} to be processed after the block B^{0/3} are added to the queue (corresponding to step S240 of FIG. 6). The block C^{0/4} which was the tail block at time t=t₀ becomes the head block at time t=t₁, and the block A^{1/3} and the block B^{1/3} are added after the block C^{1/4}.

The head block C^{0/4} and the next block A^{1/3} are fetched from the queue at time t=t₁+delta t, and processing of the block C^{0/4} is assigned to the worker processor #0 and processing of the block A^{1/3} is assigned to the worker processor #1 (corresponding to step S205 of FIG. 6). When the processing of the blocks is assigned to the respective worker processors, the respective worker processors perform the processing of the respective blocks in parallel (corresponding to step S210 of FIG. 6).

After the processing of the block C^{0/4} and the block A^{1/3} is completed at time t=t₂, the block C^{1/4} to be processed after the block C^{0/4} and the block A^{2/3} to be processed after the block A^{1/3} are added to the queue (corresponding to step S240 of FIG. 6). The block B^{1/3} which was the tail block at time t=t₁ becomes the head block at time t=t₂, and the block C^{1/4} and the block A^{2/3} are added after the block B^{1/3}.

The head block B^{1/3} and the next block C^{1/4} are fetched from the queue at time t=t₂+delta t, and processing of the block B^{1/3} is assigned to the worker processor #0 and processing of the block C^{1/4} is assigned to the worker processor #1 (corresponding to step S205 of FIG. 6). When the processing of the blocks is assigned to the respective worker processors, the respective worker processors perform the processing of the respective blocks in parallel (corresponding to step S210 of FIG. 6).

After the processing of the block B^{1/3} and the block C^{1/4} is completed at time t=t₃, the block B^{2/3} to be processed after the block B^{1/3} and the block B^{2/4} to be processed after the block C^{1/4} are added to the queue (corresponding to step S240 of FIG. 6). The block A^{2/3} which was the tail block at time t=t₂ becomes the head block at time t=t₃, and the block B^{2/3} and the block C^{2/4} are added after the block A^{2/3}.

The head block A^{2/3} and the next block B^{2/3} are fetched from the queue at time t=t₃+delta t, and processing of the block A^{2/3} is assigned to the worker processor #0 and processing of the block B^{2/3} is assigned to the worker processor #1 (corresponding to step S205 of FIG. 6). When the processing of the blocks is assigned to the respective worker processors, the respective worker processors perform the processing of the respective blocks in parallel (corresponding to step S210 of FIG. 6).

After the processing of the block A^{2/3} and the block B^{2/3} is completed at time t=t₄, processing of the slice A and the slice B is completed. Since no block is added to the queue at time t=t₄, the only block existing in the queue is the block C^{2/4}.

The block C^{2/4} is fetched from the queue at time t=t₄+delta t, and processing of the block C^{2/4} is assigned to the worker processor #0 (corresponding to step S205 of FIG. 6). When the processing of the block C^{2/4} is assigned to the worker processor #0, the worker processor #0 performs the processing of the block C^{2/4} (corresponding to step S210 of FIG. 6). Since processing of a block is not assigned to the worker processor #1, the worker processor #1 is idling.

After the processing of the block C^{2/4} is completed at time t=t₅, the block C^{3/4} to be processed after the block C^{2/4} is added to the queue (corresponding to step S240 of FIG. 6). At time t=t₅, the only block existing in the queue is the block C^{3/4}.

The block C^{3/4} is fetched from the queue at time t=t₅+delta t, and processing of the block C^{3/4} is assigned to the worker processor #0 (corresponding to step S205 of FIG. 6). When the processing of the block C^{3/4} is assigned to the worker processor #0, the worker processor #0 performs the processing of the block C^{3/4} (corresponding to step S210 of FIG. 6). Since processing of a block is not assigned to the worker processor #1, the worker processor #1 is idling.

After the processing of the block C^{3/4} is completed, processing of the slice C is completed. Since the processing of the slices A and B is completed earlier than this point of time, processing of all the slices is completed when the processing of the block C^{3/4} has been completed.

In this example, since the processing of the slice C is processed relatively later than the processing of the slices A and B, the blocks C^{2/4} and C^{3/4} of the slice C, which cannot be processed in parallel, remain when the processing of the slices A and B has been completed.

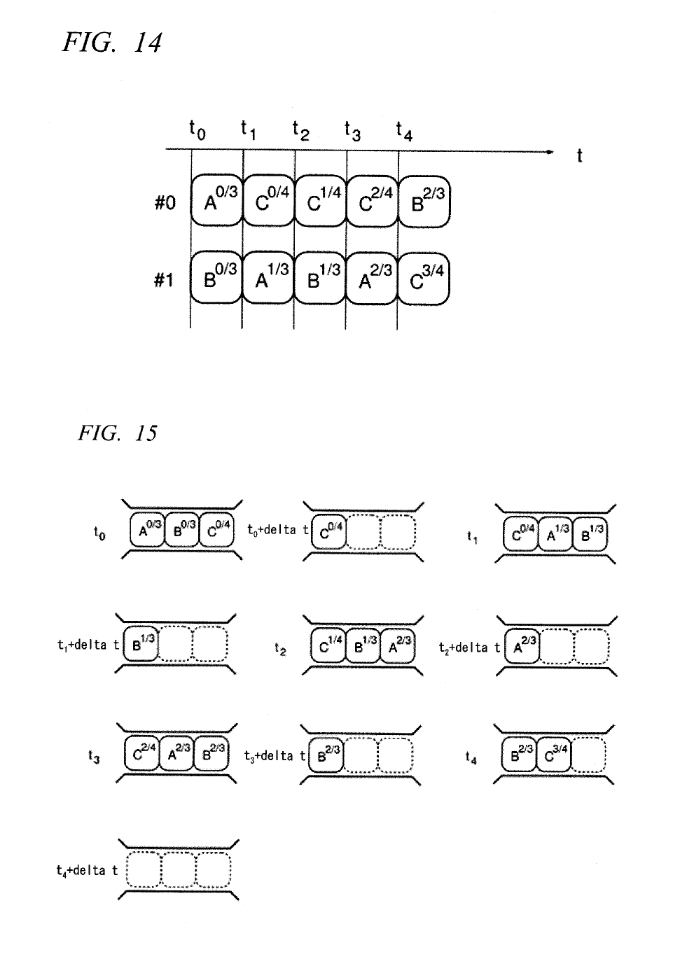

An example of decoding processing when the priority P₀ is used is shown below. FIG. 14 is a diagram illustrating a situation where blocks are assigned to each worker processor when two worker processors #0 and #1 perform decoding processing of the three slices A, B, and C. FIG. 15 is a diagram illustrating states of the queue. In the example shown in FIGS. 14 and 15, the priority P₀ is used. Slices used in the example of decoding processing when using the priority P₀ are the same as the slices shown in FIG. 11.

The priority P₀ is used as follows. When a block is added to a queue, blocks are arranged in descending order of the priorities P₀ of the respective blocks. As a result, a block with the highest priority P₀ is placed at the head of the queue and is preferentially fetched. When a plurality of blocks with the same priority P₀ exist, the plurality of blocks are arranged in the order of being added to the queue. The order of blocks within the queue is not necessarily changed when a block is added to the queue, and may be changed immediately before a block is fetched from the queue. The implementation of a queue described above is not necessarily optimal. For example, using a data structure, such as a heap, makes the implementation more efficient.

The first blocks A^{0/3}, B^{0/3}, and C^{0/4} of all the slices are added to the queue at time t =t₀ (corresponding to step S115 of FIG. 5A). At this time, it is assumed that the blocks are added to the queue in the order of the blocks A^{0/3}, B^{0/3}, and C^{0/4}. According to Equation (1), the priorities P₀ of the respective blocks are P₀(A^{0/3})=P₀(B^{0/3})=P₀(C^{0/4})=1. Since the priorities P₀ of the three blocks are equal, the order of the blocks within the queue does not change.

The head block A^{0/3} and the next block B^{0/3} are fetched from the queue at time t=t₀+delta t, and processing of the block A^{0/3} is assigned to the worker processor #0 and processing of the block B^{0/3} is assigned to the worker processor #1 (corresponding to step S205 of FIG. 5B). When the processing of the blocks is assigned to the respective worker processors, the respective worker processors start the processing in parallel (corresponding to step S210 of FIG. 5B).

After the processing of the block A^{0/3} and the block B^{0/3} is completed at time t=t₁, the block A^{1/3} to be processed after the block A^{0/3} and the block B^{1/3} to be processed after the block B^{0/3} are added to the queue (corresponding to step S240 of FIG. 5B). At this time, it is assumed that the blocks are added to the queue in the order of the blocks A^{1/3} and B^{1/3}. At time t=t₁, the block C^{0/4}, the block A^{1/3}, and the block B^{1/3} are placed in the queue. According to Equation (1), since the priorities P₀ of the respective blocks are P₀(C^{0/4})=1 and P₀(A^{1/3})=P₀(B^{1/3})=⅔, the blocks are arranged in the order of the blocks C^{0/4}, A^{1/3}, and B^{1/3} (corresponding to step S245 of FIG. 5B).

The head block C^{0/4} and the next block A^{1/3} are fetched from the queue at time t=t₁+delta t, and processing of the block C^{0/4} is assigned to the worker processor #0 and processing of the block A^{1/3} is assigned to the worker processor #1 (corresponding to step S205 of FIG. 5B). When the processing of the blocks is assigned to the respective worker processors, the respective worker processors perform the processing of the respective blocks in parallel (corresponding to step S210 of FIG. 5B).

After the processing of the block C^{0/4} and the block A^{1/3} is completed at time t=t₂, the block C^{1/4} to be processed after the block C^{0/4} and the block A^{2/3} to be processed after the block A^{1/3} are added to the queue (corresponding to step S240 of FIG. 5B). At time t=t₂, the block B^{1/3}, the block C^{1/4}, and the block A^{2/3} are placed in the queue. According to Equation (1), since the priorities P₀ of the respective blocks are P₀(B^{1/3})=⅔ and P₀(C^{1/4})=¾, and P₀(A^{2/3})=⅓, the blocks are arranged in the order of the blocks C^{1/4}, B^{1/3}, and A^{2/3} (corresponding to step S245 of FIG. 5B).

The head block C^{1/4} and the next block B^{1/3} are fetched from the queue at time t=t₂+delta t, and processing of the block C^{1/4} is assigned to the worker processor #0 and processing of the block B^{1/3} is assigned to the worker processor #1 (corresponding to step S205 of FIG. 5B). When the processing of the blocks is assigned to the respective worker processors, the respective worker processors perform the processing of the respective blocks in parallel (corresponding to step S210 of FIG. 5B).

After the processing of the block C^{1/4} and the block B^{1/3} is completed at time t=t₃, the block C^{2/4} to be processed after the block C^{1/4} and the block B^{2/3} to be processed after the block B^{1/3} are added to the queue (corresponding to step S240 of FIG. 5B). At time t=t₃, the block A^{2/3}, the block C^{2/4}, and the block B^{2/3} are placed in the queue. According to Equation (1), since the priorities P₀ of the respective blocks are P₀(A^{2/3})=P₀(B^{2/3})=⅓ and P₀(C^{2/4})= 2/4, the blocks are arranged in the order of the blocks C^{2/4}, A^{2/3}, and B^{2/3} (corresponding to step S245 of FIG. 5B).

The head block C^{2/4} and the next block A^{2/3} are fetched from the queue at time t=t₃+delta t, and processing of the block C^{2/4} is assigned to the worker processor #0 and processing of the block A^{2/3} is assigned to the worker processor #1 (corresponding to step S205 of FIG. 5B). When the processing of the blocks is assigned to the respective worker processors, the respective worker processors perform the processing of the respective blocks in parallel (corresponding to step S210 of FIG. 5B).

After the processing of the block C^{2/4} and the block A^{2/3} is completed at time t=t₄, the block C^{3/4} to be processed after the block C^{2/4} is added to the queue (corresponding to step S240 of FIG. 5B). Since the processing of the block A^{2/3} has been completed, processing of the slice A is completed. At time t=t₄, the block B^{2/3} and the block C^{3/4} are placed in the queue. According to Equation (1), since the priorities P₀ of the respective blocks are P₀(B^{2/3})=⅓ and P₀(C^{3/4})=¼, the blocks are arranged in the order of the blocks B^{2/3} and C^{3/4} (corresponding to step S245 of FIG. 5B).

The head block B^{2/3} and the next block C^{3/4} are fetched from the queue at time t=t₄+delta t, and processing of the block B^{2/3} is assigned to the worker processor #0 and processing of the block C^{3/4} is assigned to the worker processor #1 (corresponding to step S205 of FIG. 5B). When the processing of the blocks is assigned to the respective worker processors, the respective worker processors perform the processing of the respective blocks in parallel (corresponding to step S210 of FIG. 5B).

After the processing of the block B^{2/3} and the block C^{3/4} is completed, processing of the slice B and the slice C is completed. Since the processing of the slice A is completed earlier than this point of time, processing of all the slices is completed when the processing of the block B^{2/3} and the block C^{3/4} has been completed.

In this example, since the processing of the slices A, B, and C progress almost equally by preferentially processing the slice C, which is processed relatively later than the slices A and B when the priority P₀ is not used, blocks that cannot be processed in parallel do not remain at the end.

In this way, parallel processing can progress while keeping the progress ratios of processing of all the slices as equal as possible by using the priority P₀. Even in the case where the processing time cannot be precisely predicted, processing of all the slices is completed almost simultaneously because the progress ratios of processing of all the slices are kept as equal as possible. For this reason, since blocks that cannot be processed in parallel are not likely to remain at the end, a situation where processing of blocks cannot be assigned to worker processors at the end is not likely to occur. Therefore, parallel processing of slices can be performed efficiently.

<Example of Slice Decoding Processing Using Priorities P₀ and P_{1>}

An example of decoding processing in which the priority P₀ is used and an example of decoding processing in which the priorities P₀ and P₁ are used are shown. For simplicity of explanation, it is assumed that a time required for access to a queue and a time required for rearrangement of blocks can be ignored.

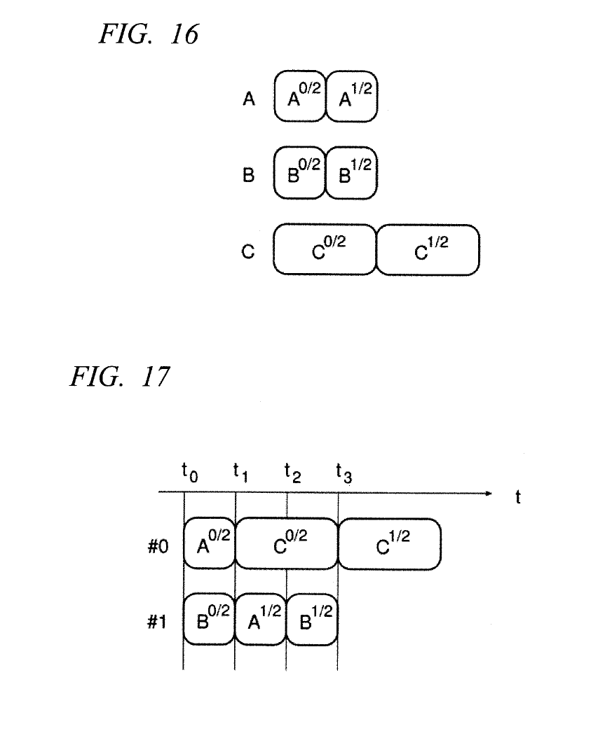

FIG. 16 is a diagram illustrating an example of slices and blocks. Referring to FIG. 16, there are three slices A, B, and C. The slices A, B, and C are configured by two blocks. The division widths of blocks of the slices A and B are equal, but the division width of blocks of the slice C is twice the division widths of the blocks of the slices A and B. Accordingly, the processing time of the slice C is twice the processing time of the slices A and B.

The slice A is divided into a block A^{0/2} and a block A^{1/2}. Each block of the slice A is processed in the order of the block A^{0/2} and the block A^{1/2}. The slice B is divided into a block B^{0/2} and a block B^{1/2}. Each block of the slice B is processed in the order of the block B^{0/2} and the block B^{1/2}. The slice C is divided into a block C^{0/2} and a block C^{1/2}. Each block of the slice C is processed in the order of the block C^{0/2} and the block C^{1/2}.

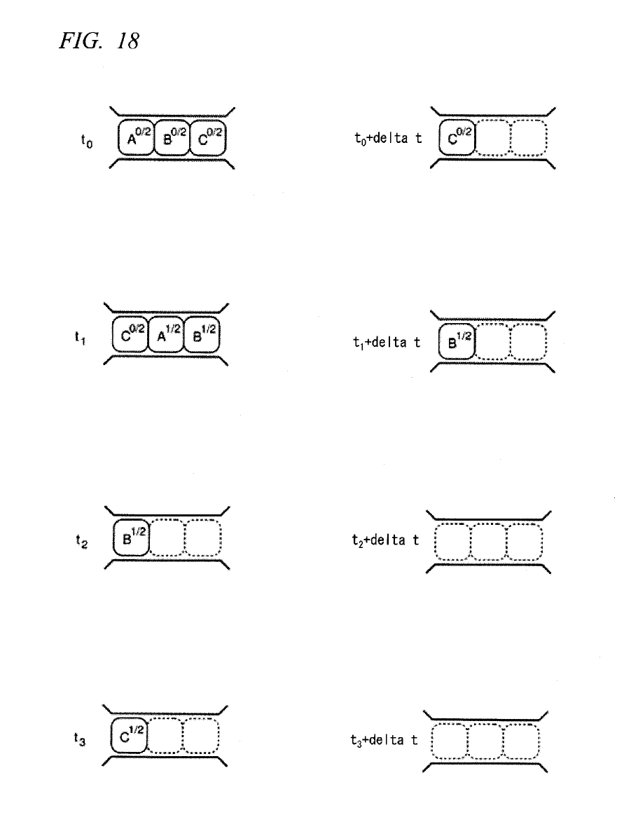

FIG. 17 is a diagram illustrating a situation where blocks are assigned to each worker processor when two worker processors #0 and #1 process the three slices A, B, and C. FIG. 18 is a diagram illustrating states of the queue. In the example shown in FIGS. 17 and 18, the priority P₀ is used.

The first blocks A^{0/2}, B^{0/2}, and C^{0/2} of all the slices are added to the queue at time t=t₀ (corresponding to step S115 of FIG. 5A). At this time, it is assumed that the blocks are added to the queue in the order of the blocks A^{0/2}, B^{0/2}, and C^{0/2}. According to Equation (1), the priorities P₀ of the respective blocks are P₀(A^{0/2})=P₀(B^{0/2})=P₀(C^{0/2})=1. Since the priorities P₀ of the three blocks are equal, the order of the blocks within the queue does not change.

The head block A^{0/2} and the next block B^{0/2} are fetched from the queue at time t=t₀+delta t, and processing of the block A^{0/2} is assigned to the worker processor #0 and processing of the block B^{0/2} is assigned to the worker processor #1 (corresponding to step S205 of FIG. 5B). When the processing of the blocks is assigned to the respective worker processors, the respective worker processors start the processing in parallel (corresponding to step S210 of FIG. 5B).

After the processing of the block A^{0/2} and the block B^{0/2} is completed at time t=t₁, the block A^{1/2} to be processed after the block A^{0/2} and the block B^{1/2} to be processed after the block B^{0/2} are added to the queue (corresponding to step S240 of FIG. 5B). At this time, it is assumed that the blocks are added to the queue in the order of the blocks A^{1/2} and B^{1/2}. According to Equation (1), since the priorities P₀ of the respective blocks placed in the queue at time t=t₁ are P₀(C^{0/2})=1 and P₀(A^{1/2})=P₀(B^{1/2})=½, the blocks are arranged in the order of the block C^{0/2}, A^{1/2}, and B^{1/2} (corresponding to step S245 of FIG. 5B).

The head block C^{0/2} and the next block A^{1/2} are fetched from the queue at time t=t₁+delta t, and processing of the block C^{0/2} is assigned to the worker processor #0 and processing of the block A^{1/2} is assigned to the worker processor #1 (corresponding to step S205 of FIG. 5B). When the processing of the blocks is assigned to the respective worker processors, the respective worker processors perform the processing of the respective blocks in parallel (corresponding to step S210 of FIG. 5B).

The processing of the block A^{1/2} is completed at time t=t₂. At this point of time, processing of the block C^{0/2} is not completed. Since the processing of the block A^{1/2} has been completed, processing of the slice A is completed. At time t=t₂, only the block B ^{1/2} is placed in the queue.

The block B^{1/2} is fetched from the queue at time t=t₂+delta t, and processing of the block B^{1/2} is assigned to the worker processor #1 (corresponding to step S205 of FIG. 5B). When the processing of the block B^{1/2} is assigned to the worker processor #1, the worker processor #1 performs the processing of the block B^{1/2} (corresponding to step S210 of FIG. 5B). At this time, the worker processor #0 continues the processing of the block C^{0/2}.

After the processing of the block B^{1/2} and the block C^{0/2} is completed at time t=t₃, the block C^{1/2} to be processed after the block C^{0/2} is added to the queue (corresponding to step S240 of FIG. 5B). Since the processing of the block B^{1/2} has been completed, processing of the slice B is completed. At time t =t₃, only the block C^{1/2} is placed in the queue.

The block C^{1/2} is fetched from the queue at time t =t₃+delta t, and processing of the block C^{1/2} is assigned to the worker processor #0 (corresponding to step S205 of FIG. 5B). When the processing of the block C^{1/2} is assigned to the worker processor #0, the worker processor #0 performs the processing of the block C^{1/2} (corresponding to step S210 of FIG. 5B). Since processing of a block is not assigned to the worker processor #1, the worker processor #1 is idling.

After the processing of the block C^{1/2} has been completed, processing of the slice C is completed. Since the processing of the slices A and B is completed earlier than this point of time, processing of all the slices is completed when the processing of the block C^{1/2} has been completed.

In this example, a block of the slice C, which requires more processing time than the blocks of the slices A and B, remains at the end.

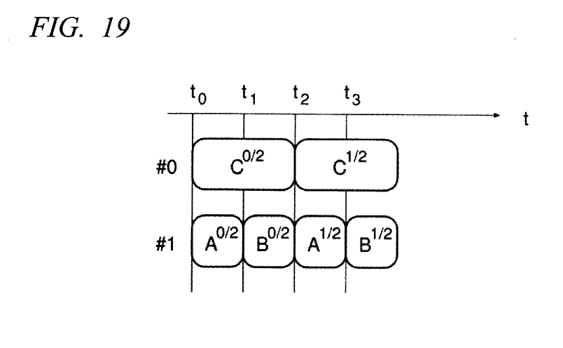

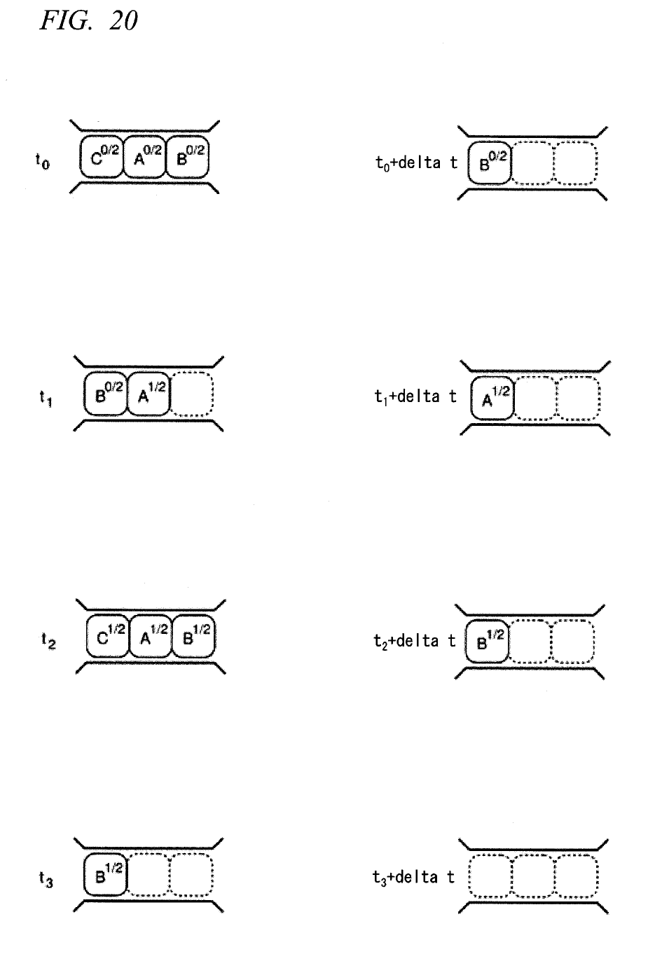

An example of processing when the priority P₁ is used in addition to the priority P₀ is shown below. FIG. 19 is a diagram illustrating a situation where blocks are assigned to each worker processor when two worker processors #0 and #1 process the three slices A, B, and C. FIG. 20 is a diagram illustrating states of the queue. In the example shown in FIGS. 19 and 20, the priorities P₀ and P₁ are used. Slices used in the example of processing using the priorities P₀ and P₁ are the same as the slices shown in FIG. 16. It is assumed that the processing times of the slices A and B is T and the processing time of the slice C is 2 T.

The priorities P₀ and P₁ are used as follows. When a block is added to a queue, the order of the blocks within the queue is determined based on the priority P₀ of each block. When a plurality of blocks with the same priority P₀ exist, the order of the plurality of blocks is determined based on the priority P₁ of each block. When a plurality of blocks with the same priority P₁ exist, the plurality of blocks are arranged in the order of being added to the queue. The order of the blocks within the queue is not necessarily changed when a block is added to the queue, and may be changed immediately before a block is fetched from the queue.

The first blocks A^{0/2}, B^{0/2}, and C^{0/2} of all the slices are added to the queue at time t=t₀ (corresponding to step S115 of FIG. 5A). At this time, it is assumed that the blocks are added to the queue in the order of the blocks A^{0/2}, B^{0/2}, and C^{0/2}. According to Equation (1), the priorities P₀ of the respective blocks are P₀(A^{0/2})=P₀(B^{0/2})=P₀(C_{0/2})=1. Since the priorities P₀ of the three blocks are equal, the priority P₁ is used. According to Equation (4), since P₁(A^{0/2})=P₁(B^{0/2})=T and P₁(C^{0/2})=2 T, the blocks are arranged in the order of the blocks C^{0/2}, A^{0/2}, and B^{0/2}.

The head block C^{0/2} and the next block A^{0/2} are fetched from the queue at time t=t₀+delta t, and processing of the block C^{0/2} is assigned to the worker processor #0 and processing of the block A^{0/2} is assigned to the worker processor #1 (corresponding to step S205 of FIG. 5B). When the processing of the blocks is assigned to the respective worker processors, the respective worker processors start the processing in parallel (corresponding to step S210 of FIG. 5B).

After the processing of the block A^{0/2} is completed at time t=t₁, the block A^{1/2} to be processed after the block A^{0/2} is added to the queue (corresponding to step S240 of FIG. 5B). At this point of time, the processing of the block C^{0/2} is not completed. At time t=t₁, the block B^{0/2} and the block A^{1/2} are placed in the queue. According to Equation (1), since the priorities P₀ of the respective blocks are P₀(B^{0/2})=1 and P₀(A^{1/2}) =½, the blocks are arranged in the order of the blocks B^{0/2} and A^{1/2} (corresponding to step S245 of FIG. 5B).

The head block B^{0/2} is fetched from the queue at time t=t₁+delta t, and processing of the block B^{0/2} is assigned to the worker processor #1 (corresponding to step S205 of FIG. 5B). When the processing of the block B^{0/2} is assigned to the worker processor #1, the worker processor #1 performs the processing of the block B^{0/2} (corresponding to step S210 of FIG. 5B). At this time, the worker processor #0 continues the processing of the block C^{0/2}.

After the processing of the block C^{0/2} and the block B^{0/2} is completed at time t=t₂, the block C^{1/2} to be processed after the block C^{0/2} and the block B^{1/2} to be processed after the block B^{0/2} are added to the queue (corresponding to step S240 of FIG. 5B). At time t=t₂, the block A^{1/2}, the block C^{1/2}, and the block B^{1/2} are placed in the queue. According to Equation (1), the priorities P₀ of the respective blocks are P₀(A^{1/2})=P₀(C ^{1/2})=P₀(B^{1/2})=½. Since the priorities P₀ of the three blocks are equal, the priority P₁ is used. According to Equation (4), since P₁(C^{1/2})=T and P₁(A^{1/2})=P₁(B^{1/2})=T/2, the blocks are arranged in the order of the blocks C^{1/2}, A^{1/2}, and B^{1/2} (corresponding to step S245 of FIG. 5B).

The head block C^{1/2} and the next block A^{1/2} are fetched from the queue at time t=t₂+delta t, and processing of the block C^{1/2} is assigned to the worker processor #0 and processing of the block A^{1/2} is assigned to the worker processor #1 (corresponding to step S205 of FIG. 5B). When the processing of the blocks is assigned to the respective worker processors, the respective worker processors perform the processing of the respective blocks in parallel (corresponding to step S210 of FIG. 5B).

The processing of the block A^{1/2} is completed at time t=t₃. Since the processing of the block A^{1/2} has been completed, processing of the slice A is completed. At this point of time, the processing of the block C^{1/2} is not completed. At time t=t₃, the block B^{1/2} is placed in the queue.

The head block B^{1/2} is fetched from the queue at time t=t₃+delta t, and processing of the block B^{1/2} is assigned to the worker processor #1 (corresponding to step S205 of FIG. 5B). When the processing of the block B^{1/2} is assigned to the worker processor #1, the worker processor #1 performs the processing of the block B^{1/2} (corresponding to step S210 of FIG. 5B). At this time, the worker processor #0 continues the processing of the block C^{1/2}.

After the processing of the block C^{1/2} and the block B^{1/2} is completed, processing of the slice C and the slice B is completed. Since the processing of the slice A is completed earlier than this point of time, processing of all the slices is completed when the processing of the C^{1/2} and the block B^{1/2} has been completed.

In this example, the block of the slice C does not remain solely at the end by preferentially processing the slice C, which requires more processing time than the slices A and B.

In this way, since the priority P₁ is used, blocks of a slice the processing time of which is relatively long are not likely to remain at the end. Accordingly, a situation where processing of a block cannot be assigned to the worker processors at the end is not likely to occur. Therefore, parallel processing of slices can be performed efficiently.

<Example of Slice Decoding Processing Using Priorities P₀, P₁, and P₂>

An example of more complicated decoding processing when using the priorities P₀, P₁, and P₂ is shown. For simplicity of explanation, it is assumed that a time required for access to a queue and a time required for rearrangement of blocks can be ignored.

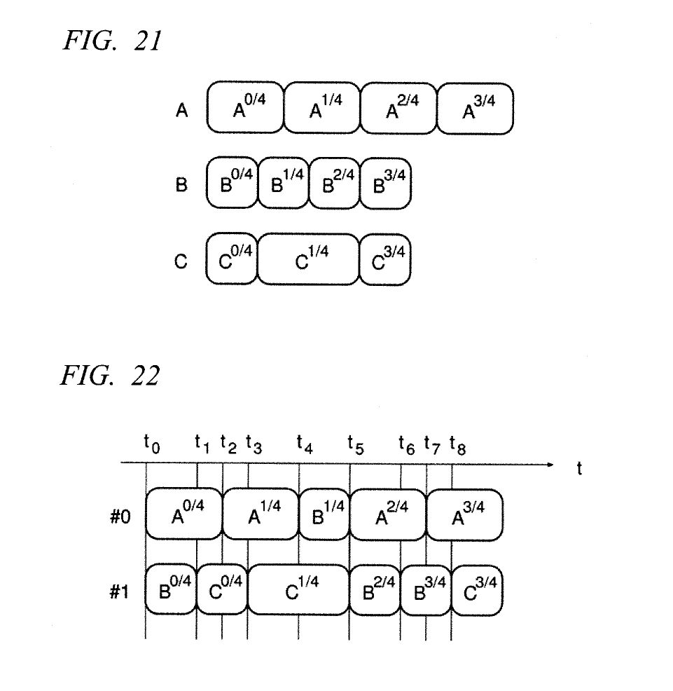

FIG. 21 is a diagram illustrating an example of slices and blocks. Referring to FIG.

21, there are three slices A, B, and C. The slices A and B are configured by four blocks, and the slice C is configured by three blocks. The slices A and B are equally divided into four blocks, but the slice C is divided into three blocks in the ratio of 1:2:1. The processing times of the slices B and C are the same, but the processing time of the slice A is 1.5 times the processing time of the slices B and C. which require the same processing time. Each block of the slice A is processed in the order of the block A^{0/4}, the block A^{1/4}, the block A^{2/4}, and the block A^{3/4}. It is assumed that the processing time of the slice A is 6 T.

The slice B is divided into a block B^{0/4}, a block B^{1/4}, a block B^{2/4}, and a block B^{3/4}, which require the same processing time. Each block of the slice B is processed in the order of the block B^{0/4}, the block B^{1/4}, the block B^{2/4}, and the block B^{3/4}. It is assumed that the processing time of the slice B is 4 T.

The slice C is divided into a block C^{0/4}, a block C^{1/4}, and a block C^{3/4}. The processing times of the blocks C^{0/4} and C^{3/4} are the same, but the processing time of the block C^{1/4} is twice the processing time of the blocks C^{0/4} and C^{3/4}. Each block of the slice C is processed in the order of the block C^{0/4}, the block C^{1/4}, and the block C^{3/4}.

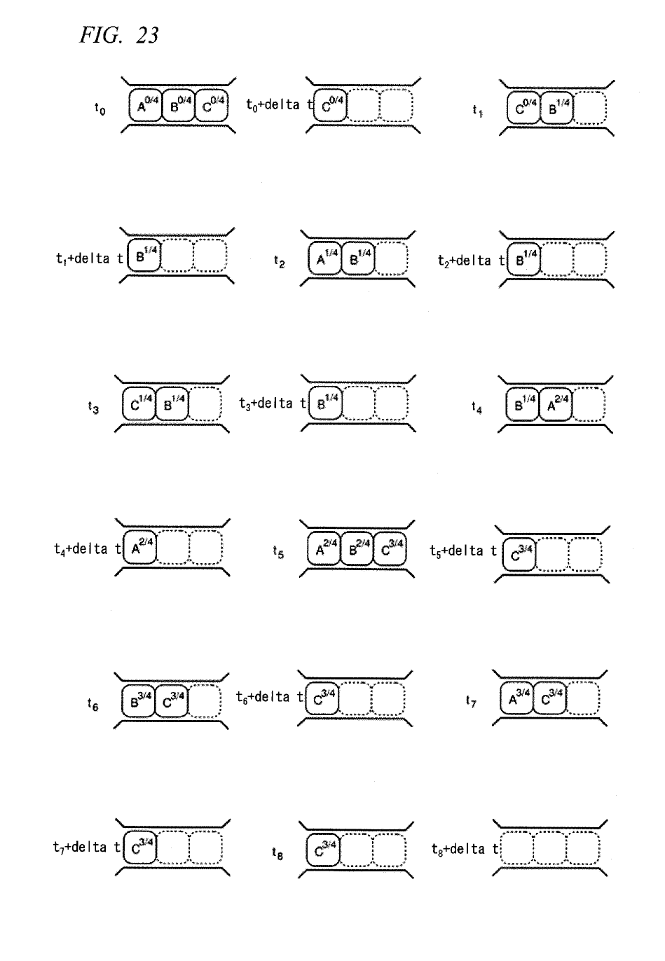

FIG. 22 is a diagram illustrating a situation where blocks are assigned to each worker processor when two worker processors #0 and #1 perform decoding processing of the three slices A, B, and C. FIG. 23 is a diagram illustrating states of the queue. In the example shown in FIGS. 22 and 23, the priorities P₀, P₁, and P₂ are used.

The priorities P₀, P₁, and P₂ are used as follows. When a block is added to the queue, the order of the blocks within the queue is determined based on the priority P₀ of each block. When a plurality of blocks with the same priority P₀ exist, the order of the plurality of blocks is determined based on the priority P₁ of each block. When a plurality of blocks with the same priority P₁ exist, the order of the plurality of blocks is determined based on the priority P₂ of each block. The order of blocks within the queue is not necessarily changed when a block is added to the queue, and may be changed immediately before a block is fetched from the queue.

The first blocks A^{0/4}, B^{0/4}, and C^{0/4} of all the slices are added to the queue at time t=t₀ (corresponding to step S115 of FIG. 5A). At this time, it is assumed that the blocks are added to the queue in the order of the blocks A^{0/4}, B^{0/4}, and C^{0/4}. According to Equation (1), the priorities P₀ of the respective blocks are P₀(A^{0/4})=P₀(B^{0/4})=P₀(C^{0/4})=1. Since the priorities P₀ of the three blocks are equal, the priority P₁ is used. According to Equation (4), since P₁(A^{0/4})=6 T and P₁(B^{0/4})=P₁(C^{0/4})=4 T, the block A^{0/4} is placed ahead of the blocks B^{0/4} and C^{0/4}.

Additionally, since the priorities P₁ of the two blocks B^{0/4} and C^{0/4} are equal, the priority P₂ is used. Since the times when the blocks B^{0/4} and C^{0/4} were added to the queue are the same, the priorities P₂ of the blocks B^{0/4} and C^{0/4} are equal. For this reason, the order of the blocks B^{0/4} and C^{0/4} is not changed. Therefore, at time t=t₀, the blocks are arranged in the order of the blocks A^{0/4}, B^{0/4}, and C^{0/4}.

The head block A^{0/4} and the next block B^{0/4} are fetched from the queue at time t=t₀+delta t, and processing of the block A^{0/4} is assigned to the worker processor #0 and processing of the block B^{0/4} is assigned to the worker processor #1 (corresponding to step S205 of FIG. 5B). When the processing of the blocks is assigned to the respective worker processors, the respective worker processors start the processing in parallel (corresponding to step S210 of FIG. 5B).

After the processing of the block B^{0/4} is completed at time t=t₁, the block B^{1/4} to be processed after the block B^{0/4} is added to the queue (corresponding to step S240 of FIG. 5B). At this point of time, the processing of the block A^{0/4} is not completed. At time t=t₁, the block C^{0/4} and the block B^{1/4} are placed in the queue. According to Equation (1), since the priorities P₀ of the respective blocks are P₀(C^{0/4})=1 and P₀(B^{1/4}) =¾, the blocks are arranged in the order of the blocks C^{0/4} and B^{1/4} (corresponding to step S245 of FIG. 5B).

The head block C^{0/4} is fetched from the queue at time t=t₁+delta t, and processing of the block C^{0/4} is assigned to the worker processor #1 (corresponding to step S205 of FIG. 5B). When the processing of the block C^{0/4} is assigned to the worker processor #1, the worker processor #1 performs the processing of the block C^{0/4} (corresponding to step S210 of FIG. 5B). At this time, the worker processor #0 continues the processing of the block A^{0/4}.

After the processing of the block A^{0/4} is completed at time t=t₂, the block A^{1/4} to be processed after the block A^{0/4} is added to the queue (corresponding to step S240 of FIG. 5B). At this point of time, the processing of the block C^{0/4} is not completed. At time t=t₂, the block B^{1/4} and the block A^{1/4} are placed in the queue. According to Equation (1), the priorities P₀ of the respective blocks are P₀(B^{1/4})=¾ and P₀(A^{1/4})=¾. Since the priority P₀ of each block is the same, the priority P₁ is used. According to Equation (4), since P₁(B^{1/4})=3 T and P₁(A^{1/4})=4.5 T, the blocks are arranged in the order of the blocks A^{1/4} and B^{1/4} (corresponding to step S245 of FIG. 5B).

The head block A^{1/4} is fetched from the queue at time t=t₂+delta t, and processing of the block A^{1/4} is assigned to the worker processor #0 (corresponding to step S205 of FIG. 5B). When the processing of the block A^{1/4} is assigned to the worker processor #0, the worker processor #0 performs the processing of the block A^{1/4} (corresponding to step S210 of FIG. 5B). At this time, the worker processor #1 continues the processing of the block C^{0/4}.

After the processing of the block C^{0/4} is completed at time t=t₃, the block C^{1/4} to be processed after the block C^{0/4} is added to the queue (corresponding to step S205 of FIG. 5B). At this point of time, the processing of the block A^{1/4} is not completed. At time t=t₃, the block B^{1/4} and the block C^{1/4} are placed in the queue. According to Equation (1), the priorities P₀ of the respective blocks are P₀(B^{1/4})=¾ and P₀(C^{1/4})=¾. Since the priorities P₀ of the respective blocks are the same, the priority P₁ is used. According to Equation (4), P₁(B^{1/4})=3 T and P₁(C^{1/4})=3 T.

Since the priorities P₁ of the respective blocks are the same, the priority P₂ is used. The priorities P₂ of the respective blocks are P₂(B^{1/4})=t₁ and P₂(C^{1/4})=t₃. By using the priority P₂, the blocks are arranged in the order of the blocks C^{1/4} and B^{1/4} (corresponding to step S245 of FIG. 5B) and a block added to the queue at a later time is processed more preferentially than a block added to the queue at an earlier time.

The head block C^{1/4} is fetched from the queue at time t=t₃+delta t, and processing of the block C^{1/4} is assigned to the worker processor #1 (corresponding to step S205 of FIG. 5B). When the processing of the block C^{1/4} is assigned to the worker processor #1, the worker processor #1 performs the processing of the block C^{1/4} (corresponding to step S210 of FIG. 5B). At this time, the worker processor #0 continues the processing of the block A^{1/4}.

After the processing of the block A^{1/4} is completed at time t=t₄, the block A^{2/4} to be processed after the block A^{1/4} is added to the queue (corresponding to step S240 of FIG. 5B). At this point of time, the processing of the block C^{1/4} is not completed. At time t=t₄, the block B^{1/4} and the block A^{2/4} are placed in the queue. According to Equation (1), since the priorities P₀ of the respective blocks are P₀(B^{1/4})=¾ and P₀(A ^{2/4})= 2/4, the blocks are arranged in the order of the blocks B^{1/4} and A^{2/4} (corresponding to step S245 of FIG. 5B).

The head block B^{1/4} is fetched from the queue at time t=t₄+delta t, and processing of the block B^{1/4} is assigned to the worker processor #0 (corresponding to step S205 of FIG. 5B). When the processing of the block B^{1/4} is assigned to the worker processor #0, the worker processor #0 performs the processing of the block B^{1/4} (corresponding to step S210 of FIG. 5B). At this time, the worker processor #1 continues the processing of the block C^{1/4}.

After the processing of the block B^{1/4} and the block C^{1/4} is completed at time t=t₅, the block B^{2/4} to be processed after the block B^{1/4} and the block C^{3/4} to be processed after the block B^{2/4} are added to the queue (corresponding to step S240 of FIG. 5B). At time t=t₅, the block A^{2/4}, the block B^{2/4}, and the block C^{3/4} are placed in the queue.

According to Equation (1), since the priorities P₀ of the respective blocks are P₀(A^{2/4}) =P₀(B^{2/4})= 2/4 and P₀(C^{3/4})=¼, the blocks A^{2/4} and B^{2/4} are placed ahead of the block C^{3/4}. Since the priorities P₀ of the two blocks A^{2/4} and B^{2/4} are equal, the priority P₁ is used. According to Equation (4), since P₁(A^{2/4})=3 T and P₁(B^{2/4})=2 T, the block A^{2/4} is placed ahead of the block B^{2/4}. Therefore, at time t =t₅, the blocks are arranged in the order of the blocks A^{2/4}, B^{2/4}, and C^{3/4} (corresponding to step S245 of FIG. 5B).

The head block A^{2/4} and the next block B^{2/4} are fetched from the queue at time t=t₅+delta t, and processing of the block A^{2/4} is assigned to the worker processor #0 and processing of the block B^{2/4} is assigned to the worker processor #1 (corresponding to step S205 of FIG. 5B). When the processing of the blocks is assigned to the respective worker processors, the respective worker processors start the processing in parallel (corresponding to step S210 of FIG. 5B).

After the processing of the block B^{2/4} is completed at time t=t₆, the block B^{3/4} to be processed after the block B^{2/4} is added to the queue (corresponding to step S240 of FIG. 5B). At this point of time, the processing of the block A^{2/4} is not completed. At time t=t₆, the block C^{3/4} and the block B^{3/4} are placed in the queue. According to Equation (1), the priorities P₀ of the respective blocks are P₀(C^{3/4})=P₀(B^{3/4})=¼. Since the priority P₀ of each block is the same, the priority P₁ is used. According to Equation (4), P₁(C^{3/4})=P₁(B^{3/4})=T.

Since the priority P₁ of each block is the same, the priority P₂ is used. The priorities P₂ of the respective blocks are P₂(C^{3/4})=t₅ and P₂(B^{3/4})=t₆. By using the priorities P₂, a block added to the queue at a later time is processed more preferentially than a block added to the queue at an earlier time. Accordingly, the blocks are arranged in the order of the blocks B^{3/4} and C^{3/4} (corresponding to step S245 of FIG. 5B).

The head block B^{3/4} is fetched from the queue at time t=t₆+delta t, and processing of the block B^{3/4} is assigned to the worker processor #1 (corresponding to step S205 of FIG. 5B). When the processing of the block B^{3/4} is assigned to the worker processor #1, the worker processor #1 performs the processing of the block B^{3/4} (corresponding to step S210 of FIG. 5B). At this time, the worker processor #0 continues the processing of the block A^{2/4}.

After the processing of the block A^{2/4} is completed at time t=t₇, the block A^{3/4} to be processed after the block A^{2/4} is added to the queue (corresponding to step S240 of FIG. 5B). At this point of time, the processing of the block B^{3/4} is not completed. At time t=t₇, the block C^{3/4} and the block A^{3/4} are placed in the queue. According to Equation (1), the priorities P₀ of the respective blocks are P₀(C^{3/4})=P₀(A^{3/4})=¼. Since the priority P₀ of each block is the same, the priority P₁ is used. According to Equation (4), since P₁(C^{3/4})=T and P₁(A^{3/4})=1.5 T, the blocks are arranged in the order of the blocks A^{3/4} and C^{3/4} (corresponding to step S245 of FIG. 5B).

The head block A^{3/4} is fetched from the queue at time t=t₇+delta t, and processing of the block A^{3/4} is assigned to the worker processor #0 (corresponding to step S205 of FIG. 5B). When the processing of the block A^{3/4} is assigned to the worker processor #0, the worker processor #0 performs the processing of the block A^{3/4} (corresponding to step S210 of FIG. 5B). At this time, the worker processor #1 continues the processing of the block B^{3/4}.

The processing of the block B^{3/4} is completed at time t=t₈. Since the processing of the block B^{3/4} has been completed, processing of the slice B is completed. At this point of time, the processing of the block A^{3/4} is not completed. At time t=t₈, the block C^{3/4} is placed in the queue.

The head block C^{3/4} is fetched from the queue at time t=t₈+delta t, and processing of the block C^{3/4} is assigned to the worker processor #1 (corresponding to step S205 of FIG. 5B). When the processing of the block C^{3/4} is assigned to the worker processor #1, the worker processor #1 performs the processing of the block C^{3/4} (corresponding to step S210 of FIG. 5B). At this time, the worker processor #0 continues the processing of the block A^{3/4}.

After the processing of the block A^{3/4} and the block C^{3/4} is completed, processing of the slices A and C is completed. Since the processing of the slice B is completed earlier than this point of time, processing of all the slices is completed when the processing of the A^{3/4} and the block C^{3/4} has been completed.

In this example, since the priority P₀ is used, parallel processing can progress while keeping the progress ratio of processing of all the slices as equal as possible. Additionally, since the priority P₁ is used, the block of the slice A, the processing time of which is relatively long, does not remain solely at the end. Therefore, parallel processing of slices can be performed efficiently.

Furthermore, in this example, by using the priority P₂, the worker processor #1 performs processing of the blocks C^{0/4} and C^{1/4} of the slice C continuously and performs processing of the blocks B^{2/4} and B^{3/4} of the slice B continuously. In this way, by performing processing of blocks of the same slice continuously, the cache efficiency is increased and the processing speed is improved.

As described above, according to the first embodiment, since processing is assigned to worker processors in the unit of blocks obtained by dividing a slice, compared with a case where processing is assigned to worker processors in the unit of a slice, it is possible to reduce the possibility that some worker processors are idling because each worker processor is waiting its turn for processing and thus subjects to be processed are not provided thereto. Accordingly, the total idling time of the entire worker processors is reduced. As a result, the efficiency in using the entire worker processors is increased. Therefore, the speed of decoding processing of an encoded slice is improved.

Irrespective of the number N of processors and the number M of slices, processing of slices is assigned to all the worker processors as equally as possible by the same method. In particular, even if the processing time of each slice is not known beforehand or the processing time of each slice cannot be precisely predicted, the processing proceeds while keeping the progress of all the slices almost equal. Accordingly, the ratio of time for which processing can be processed in parallel to the total processing time is increased, and thus the worker processors can be used efficiently.

Since only worker processors, the number of which is the same as the number of processors, which correspond to the CPUs in a one-to-one manner are used, context switches between the worker processors do not occur during processing of slices. The context switch is an operation of storing or restoring an execution state (context) of a processor in order that a plurality of worker processors share the same processor. Since the context switches between the worker processors do not occur, a drop in the processing speed is prevented.

Even in the case where the processing time of a slice is smaller than the time quantum of the OS, each worker processor can perform processing in parallel in the unit of blocks. By executing processing while switching a plurality of slices at short intervals, a larger number of slices than the number of processors can be virtually processed in parallel.

Only blocks which can be processed in parallel are placed in a queue, and a wrapper block fetched from the queue is immediately assigned to an arbitrary worker processor. Accordingly, synchronous processing other than access to the queue is not necessary during processing of slices.

### Second Embodiment

A second embodiment of the present invention is examples of an editing apparatus and an editing method for decoding encoded image data.

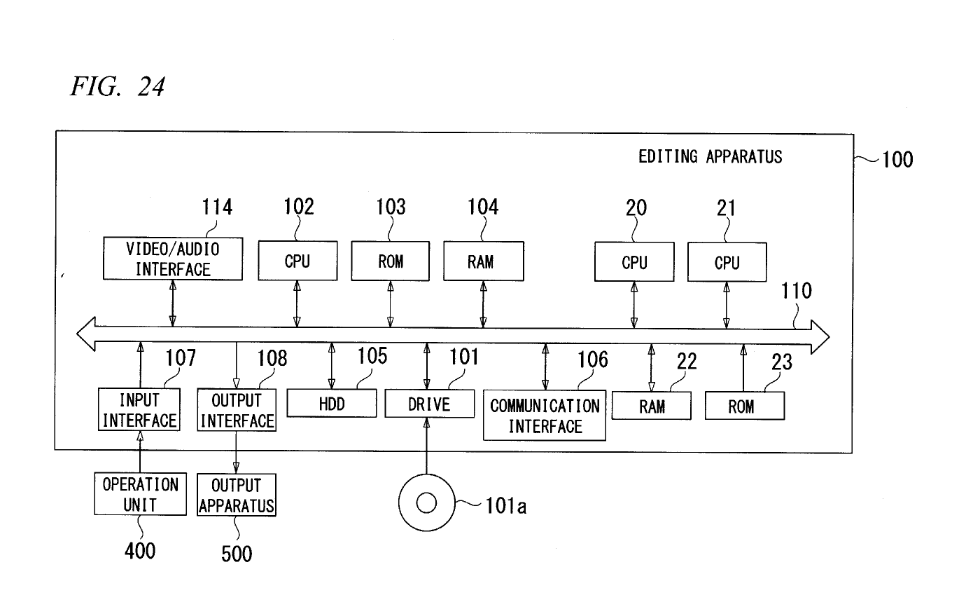

FIG. 24 is a block diagram illustrating the hardware configuration of an editing apparatus according to the second embodiment of the present invention. It is noted that the same reference symbols are given to components which are common in the first embodiment, and the explanations thereof will be omitted.

Referring to FIG. 24, an editing apparatus 100 includes a drive 101 for driving an optical disk or other recording media, a CPU 20, a CPU 21, a CPU 102, a ROM 23, a ROM 103, a RAM 22, a RAM 104, an HDD 105, a communication interface 106, an input interface 107, an output interface 108, a video/audio interface 114, and a bus 110 which connects them.

The editing apparatus 100 has the same decoding apparatus as the decoding apparatus according to the first embodiment, which is configured by the CPU 20, the CPU 21, the RAM 22, and ROM 23 shown in previous FIG. 1. Additionally, although not shown in FIG. 24, the editing apparatus 100 has the same functional configuration as the functional configuration shown in previous FIG. 3. The editing apparatus 100 also has an encoding processing function and an editing function. It is noted that the encoding processing function is not essential to the editing apparatus 100.

A removable medium 101a is mounted in the drive 101, and data is read from the removable medium 101a. The drive 101 may be an external drive. The drive 101 may adopt an optical disk, a magnetic disk, a magneto-optic disk, a Blu-ray disc, a semiconductor memory, or the like. Material data may be read from resources on a network connectable through the communication interface 106.

The CPU 102 loads a control program recorded in the ROM 103 into the RAM 104 and controls the entire operation of the editing apparatus 100.

The HDD 105 stores an application program as the editing apparatus. The CPU 102 loads the application program into the RAM 104 and makes a computer operate as the editing apparatus. Additionally, the material data read from the removable medium 101a, edit data of each clip, and the like may be stored in the HDD 105.

The communication interface 106 is an interface such as a USB (Universal Serial Bus), a LAN, or an HDMI.

The input interface 107 receives an instruction input by a user through an operation unit 400, such as a keyboard or a mouse, and supplies an operation signal to the CPU 102 through the bus 110.

The output interface 108 supplies image data and/or audio data from the CPU 102 to an output apparatus 500, for example, a display apparatus, such as an LCD (liquid crystal display) or a CRT, or a speaker.

The video/audio interface 114 communicates data with apparatuses provided outside the editing apparatus 100 and with the bus 110. For example, the video/audio interface 114 is an interface based on an SDI (Serial Digital Interface) or the like.

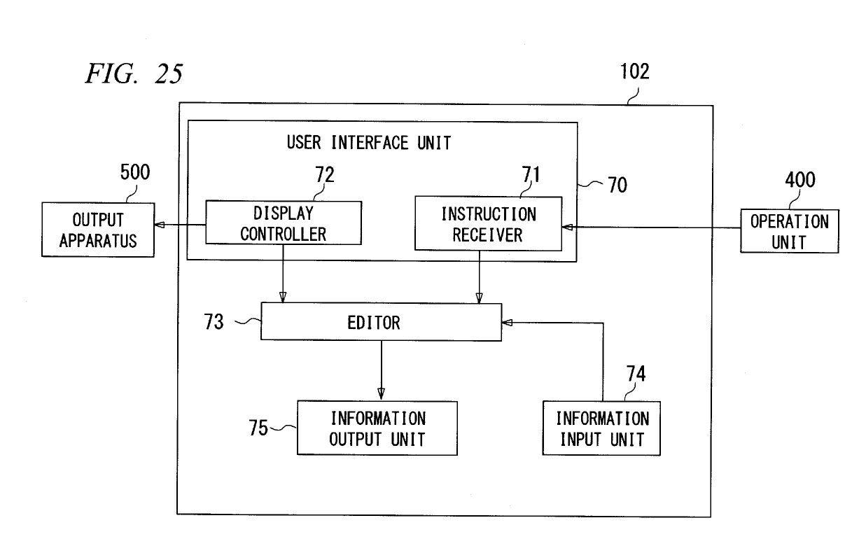

FIG. 25 is a diagram illustrating the functional configuration of the editing apparatus according to the second embodiment of the present invention.

Referring to FIG. 25, the CPU 102 of the editing apparatus 100 forms respective functional blocks of a user interface unit 70, an editor 73, an information input unit 74, and an information output unit 75 by using the application program loaded into a memory.

Such respective functional blocks realize an import function of a project file including material data and edit data, an editing function for each clip, an export function of a project file including material data and/or edit data, a margin setting function for material data at the time of exporting a project file, and the like. Hereinafter, the editing function will be described in detail.

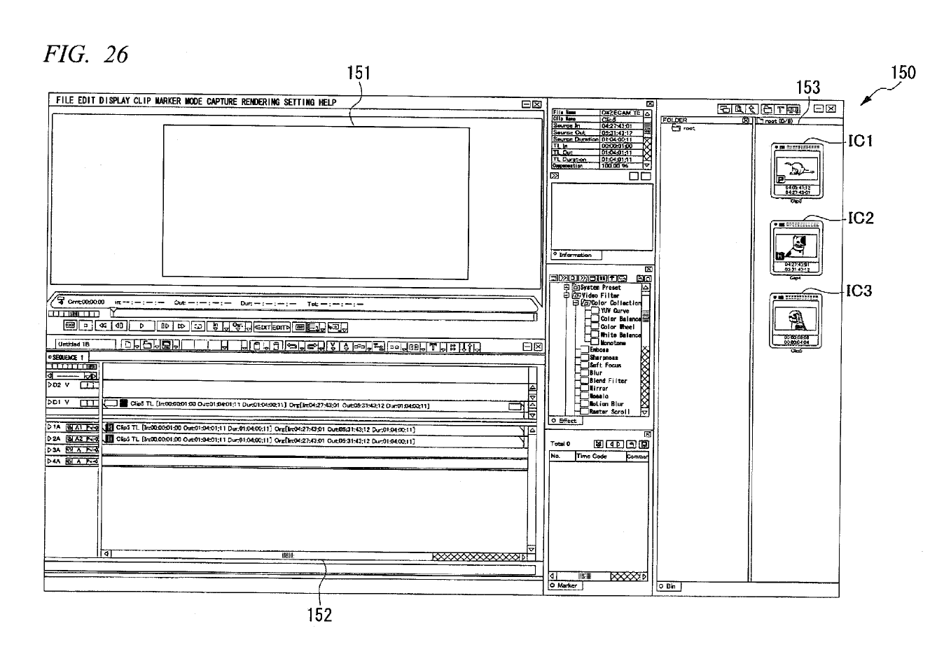

FIG. 26 is a diagram illustrating an example of an edit screen of the editing apparatus according to the second embodiment of the present invention.

Referring to FIG. 26 together with FIG. 25, display data of the edit screen is generated by a display controller 72 and is output to a display of the output apparatus 500.

An edit screen 150 includes: a playback window 151 which displays a playback screen of edited contents and/or acquired material data; a timeline window 152 configured by a plurality of tracks in which each clip is disposed along a timeline; and a bin window 153 which displays acquired material data by using icons or the like.

The user interface unit 70 includes: an instruction receiver 71 which receives an instruction input by the user through the operation unit 400; and the display controller 72 which performs a display control for the output apparatus 500, such as a display or a speaker.

The editor 73 acquires material data which is referred to by a clip that is designated by the instruction input from the user through the operation unit 400, or material data which is referred to by a clip including project information designated by default, through the information input unit 74. Additionally, the editor 73 performs editing processing, such as arrangement of clips to be described later on the timeline window, trimming of a clip, or setting of transition between scenes, application of a video filter, and the like according to the instruction input from the user through the operation unit 400.

When material data recorded in the HDD 105 has been designated, the information input unit 74 displays an icon on the bin window 153. When material data not recorded in the HDD 105 has been designated, the information input unit 74 reads material data from resources on the network, removable media, or the like and displays an icon on the bin window 153. In the illustrated example, three pieces of material data are displayed by using icons IC1 to IC3.

The instruction receiver 71 receives, on the edit screen, a designation of a clip used in editing, a reference range of material data, and a time position on the time axis of contents occupied by the reference range. Specifically, the instruction receiver 71 receives a designation of a clip ID, the starting point and the time length of the reference range, time information on contents in which the clip is arranged, and the like. Accordingly, the user drags and drops an icon of desired material data on the timeline using a displayed clip name as a clue. The instruction receiver 71 receives the designation of the clip ID by this operation, and the clip is disposed on a track with the time length corresponding to the reference range referred to by the selected clip.

For the clip disposed on the track, the starting point and the end point of the clip, time arrangement on the timeline, and the like may be suitably changed. For example, a designation can be input by moving a mouse cursor displayed on the edit screen to perform a predetermined operation.

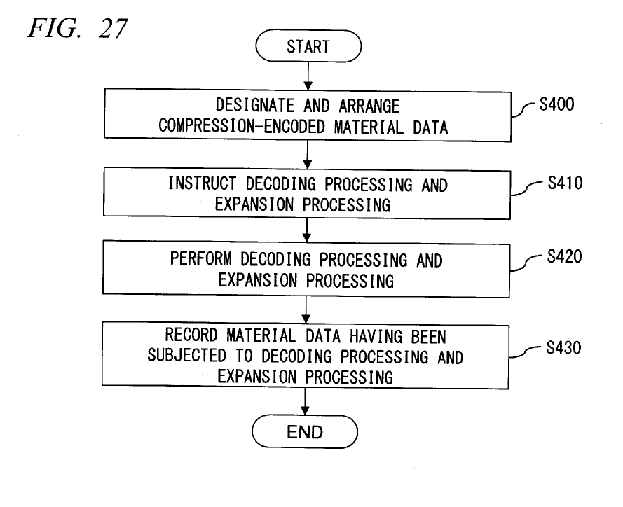

FIG. 27 is a flow chart illustrating an editing method according to the second embodiment of the present invention. The editing method according to the second embodiment of the present invention will be described referring to FIG. 27 using a case where compression-encoded material data is edited as an example.

First, in step S400, when the user designates encoded material data recorded in the HDD 105, the CPU 102 receives the designation and displays the material data on the bin window 153 as an icon. Additionally, when the user makes an instruction to arrange the displayed icon on the timeline window 152, the CPU 102 receives the instruction and disposes a clip of a material on the timeline window 152.

Then, in step S410, when the user selects, for example, decoding processing and expansion processing for the material from among the edit contents which are displayed by the predetermined operation through the operation unit 400, the CPU 102 receives the selection.

Then, in step S420, the CPU 102, which has received the instruction of decoding processing and expansion processing, outputs instructions of decoding processing and expansion processing to the CPUs 20 and 21. The CPUs 20 and 21, to which the instructions of decoding processing and expansion processing from the CPU 102 have been input, performs decoding processing and expansion processing on the compression-encoded material data. In this case, the CPUs 20 and 21 generate decoded material data by executing the decoding method according to the first embodiment.

Then, in step S430, the CPUs 20 and 21 store the material data generated in step S420 in the RAM 22 through the bus 110. The material data temporarily stored in the RAM 22 is recorded in the HDD 105. It is noted that instead of recording the material data in the HDD, the material data may be output to apparatuses provided outside the editing apparatus.

It is noted that trimming of a clip, setting of transition between scenes, and/or application of a video filter may be performed between steps S400 and S410. In the case of performing such processing, decoding processing and expansion processing in step S420 are performed for a clip to be processed or a part of the clip. Thereafter, the processed clip or the part of the clip is stored. It is synthesized with another clip or another portion of the clip at the time of subsequent rendering.

According to the second embodiment, since the editing apparatus has the same decoding apparatus as in the first embodiment and decodes encoded material data using the same decoding method as in the first embodiment, the same advantageous effects as in the first embodiment are obtained, and the efficiency of decoding processing is improved.

It is noted that at the time of decoding processing, the CPU 102 may execute the same step as for the CPU 20 and the CPU 21. In particular, it is preferable that the steps are executed in a period for which the CPU 102 does not perform processing other than the decoding processing.

Having described preferred embodiments of the present invention in detail, the present invention is not limited to those specific embodiments but various changes and modifications thereof are possible within the scope of the present invention as defined in the claims. For example, the present invention may also be applied to decoding processing of encoded audio data. For example, although the embodiments have been described using decoding processing based on MPEG-2 as an example, it is needless to say that it is not limited to MPEG-2 but may also be applied to other image encoding schemes, for example, MPEG-4 visual, MPEG-4 AVC, FRExt (Fidelity Range Extension), or audio encoding schemes.

### Reference Signs List

10 Decoding Apparatus

20, 21 CPU

22 RAM

23 ROM

30 decoding processing unit

31 main processor

32a, 32b Worker Processor

33a, 33b Slice Decoder

34 Queue

35 Slice Buffer

36 Video Memory

37 Slice Context

73 Editor

100 Editing Apparatus

1-13. (canceled)

14. An apparatus for decoding encoded data of image data or audio data, the apparatus comprising:
a memory providing said encoded data including a plurality of pieces of element data being able to be decoded independently, each of the plurality of pieces of element data including at least one block;
a first processor generating block information identifying a first block to be processed first among said at least one block;
a plurality of second processors generating block information identifying a subsequent block to the first block based on an order of decoding processing in element data corresponding to the block information;
a plurality of decoders decoding, in parallel, a block identified by referring to one piece of block information which was not referred yet among the generated block information; and
a memory storing the decoded block and forming decoded element data corresponding to the block, wherein
for a block corresponding to block information which was referred yet among the bock information generated by the second processing means, a priority representing the order of decoding processing associated with the block is calculated.

15. The apparatus according to claim 14, wherein the priority is based on a ratio in which decoding processing of the corresponding element data has progressed.

16. The apparatus according to claim 14, wherein the priority is based on the processing time of unprocessed blocks of the corresponding element data.

17. The apparatus according to claim 14, further comprising a
memory storing the generated block information,
wherein the decoder preferentially decodes a block identified based on a time at which the block information is stored.

18. A method for decoding encoded data of image data or audio
data, the method comprising the steps of:
generating, in a processor, block information identifying a block which is processed first among at least one block which configures each of a plurality of pieces of element data included in said encoded data, the element data being able to be decoded independently, an order of decoding processing in element data corresponding to the block being given to the block;
calculating a priority representing the order of processing for decoding for a block corresponding to the generated block information;
associating the priority with the block;
decoding, in a plurality of processors, a block corresponding to block information with the highest priority by referring to priorities of a plurality of pieces of the generated block information which was not referred yet in parallel;
generating, in the plurality of processors, block information identifying a subsequent block which belongs to element data configured by the decoded block in parallel based on the order of decoding processing; and
repeating the step of decoding and the step of generating the block information identifying the subsequent block until all the blocks are decoded.

19. The method according to claim 18, wherein the priority is based on a ratio in which decoding processing of the corresponding element data has progressed.

20. The method according to claim 18, wherein the priority is based on the processing time of unprocessed blocks of the corresponding element data.

21. The method according to claim 18, further comprising the step of storing the generated block information in a memory,
wherein in the step of decoding the block, the plurality of processors preferentially decode a block identified based on a time at which the block information is stored in the memory.

22. A recording medium recording a program for decoding encoded data of image data or audio data, the program being configured to make a processor execute the step of
generating block information identifying a block which is processed first among at least one block which configures each of a plurality of pieces of element data included in encoded data including image data or audio data, the element data being able to be decoded independently, an order of decoding processing in element data corresponding to the block being given to the block, and
to make a plurality of processors execute the steps of:
calculating a priority representing the order of processing for decoding for a block corresponding to the generated block information;
associating the priority with the block;
decoding a block corresponding to block information with the highest priority by referring to priorities of a plurality of pieces of the generated block information which was not referred yet in parallel;
generating block information identifying a subsequent block which belongs to element data configured by the decoded block in parallel based on the order of the decoding processing; and
repeating the step of decoding and the step of generating the block information identifying the subsequent block until all the blocks are decoded.

23. An editing apparatus comprising:
a memory providing encoded data of image data or audio data, the encoded data including a plurality of pieces of element data being able to be decoded independently, each of the plurality of pieces of element data including at least one block;
a first processor generating block information identifying a block to be processed first among said at least one block;
a plurality of second processors generating block information identifying a subsequent block to the first block based on an order of decoding processing in element data corresponding to the block information;
a plurality of decoders decoding, in parallel, a block identified by referring to one piece of unreferenced block information among the generated block information;
a memory storing the decoded block and forming decoded element data corresponding to the block; and
an editor editing the decoded element data , wherein
for a block corresponding to block information which was referred yet among the bock information generated by the second processing means, a priority representing the order of decoding processing associated with the block is calculated.
